(19) United States
(12) Patent Application Publication
(10) Pub. No.: US 2026/0045088 A1
(43) Pub. Date: Feb. 12, 2026

(54) Skyward Facing Helmet Camera and Associated Methods with Artificial Intelligence

(71) Applicants: Raj ABHYANKER, Mountain View, CA (US); Ohad BARAK, Mountain View, CA (US); Goktug DUMAN, Maimi, FL (US)

(72) Inventors: Raj ABHYANKER, Mountain View, CA (US); Ohad BARAK, Mountain View, CA (US); Goktug DUMAN, Maimi, FL (US)

(21) Appl. No.: 18/740,560

(22) Filed: Jun. 12, 2024

Related U.S. Application Data
(63) Continuation-in-part of application No. 18/596,684, filed on Mar. 6, 2024, now Pat. No. 12,392,583.
(63) Continuation-in-part of application No. 18/634,891, filed on Apr. 13, 2024.
(60) Provisional application No. 63/614,022, filed on Dec. 22, 2023.
(60) Provisional application No. 63/622,514, filed on Jan. 18, 2024.
(60) Provisional application No. 63/626,075, filed on Jan. 29, 2024.
(60) Provisional application No. 63/554,360, filed on Feb. 16, 2024.

(51) Int. Cl. G06V 20/52; A42B 3/04; G01S 7/38; G01S 13/88; G03B 17/56; G06V 10/82; G08B 6/00; H04N 23/57

(52) U.S. Cl. CPC G06V 20/52; A42B 3/042; A42B 3/046; G01S 7/38; G01S 13/886; G03B 17/561; G06V 10/82; G08B 6/00; H04N 23/57; G06V 2201/08

(57) ABSTRACT

Disclosed are a method, system, and apparatus of a skyward facing helmet camera and associated methods with artificial intelligence. In one embodiment, a low profile, concavely curved camera housing includes a skyward facing visual sensor, an artificial intelligence model communicatively coupled with the skyward facing visual sensor, and a responsive device. The skyward facing visual sensor on a top surface of the low profile, concavely curved camera housing captures an ambient sky above a wearer of a helmet. The artificial intelligence model detects an object of interest (e.g., a drone, a bird, a plane, a missile, a satellite, an ambient threat, and a celestial object) appearing above the wearer. The responsive device haptically notifies the wearer when the artificial intelligence model detects the object of interest.

### CLAIM OF PRIORITY

This Application is a conversion Application of, claims priority to, and incorporates by reference herein the entirety of the disclosures of:

U.S. Provisional Patent Application No. 63/614,022 titled MULTI-FUNCTIONAL WEARABLE AI-ENABLED PENDANT APPARATUS, SYSTEM, AND METHOD OF AMBIENT DATA ANALYSIS AND COMMUNICATION IN LAW ENFORCEMENT, FIRE, MEDICAL RESPONDER, PRIVATE SECURITY, JOURNALISM, COMMERCIAL AND MILITARY OPERATIONAL ENVIRONMENTS filed on Dec. 22, 2023;

U.S. Provisional Patent Application No. 63/622,514 titled HAPTIC FEEDBACK RESPONSIVE TO A THREAT IDENTIFIED THROUGH A GENERATIVE ARTIFICIAL INTELLIGENCE BODY WORN APPARATUS filed on Jan. 18, 2024;

U.S. Provisional Patent Application No. 63/626,075 titled SECURE EDGE MESH NETWORK SYSTEM FOR ENHANCED VISUAL INTERPRETATION AND REAL-TIME SITUATIONAL AWARENESS IN COMBAT ZONES filed on Jan. 29, 2024;

U.S. Provisional Patent Application No. 63/554,360 titled ENHANCED SITUATIONAL AWARENESS THROUGH A HAPTIC WEARABLE DEVICE OF A POLICE OFFICER OR A WARFIGHTER, ACTIVATED BY A NEARBY NETWORKED VEHICLE OR A STATIONARY SENSOR UPON DETECTING A THREAT filed on Feb. 16, 2024;

U.S. Utility patent application Ser. No. 18/596,684 titled BODY SAFETY DEVICE WITH VISUAL SENSING AND HAPTIC RESPONSE USING ARTIFICIAL INTELLIGENCE filed on Mar. 6, 2024; and

U.S. Utility patent application Ser. No. 18/634,891 titled CORRECTIONS OFFICER TACTICAL GEAR, SYSTEM AND METHOD USING COMPUTER VISION TO NOTIFY OF AN AMBIENT THREAT filed on Apr. 13, 2024.

### FIELD OF TECHNOLOGY

The present disclosure relates generally to the field of situational awareness technology. This disclosure relates generally to a skyward facing helmet camera and associated methods with artificial intelligence.

### BACKGROUND

In civilian scenarios, birdwatchers often face the challenge of missing out on sighting birds in the sky because they may not always be looking up at the right moment. This problem is compounded by the unpredictable nature of bird movements and the vast expanse of the sky, making it easy to overlook even significant bird activity. Consequently, birdwatchers might miss rare or interesting species, reducing the overall experience and success of their birdwatching endeavors.

Similarly, stargazers often struggle with the challenge of not observing all areas of the night sky, leading to missed opportunities to witness celestial events and phenomena. This limitation is due to the vastness of the sky, coupled with the need to constantly adjust focus and direction. As a result, even dedicated astronomers can miss out on rare sightings of meteor showers, passing satellites, or the appearance of distant planets and stars. The inability to monitor the entire sky simultaneously diminishes the overall stargazing experience and can result in significant observational gaps.

In military scenarios, despite the importance of monitoring the skies, soldiers often feel compelled to focus their attention in front and behind them due to human psychology and the nature of ground combat. Humans have a natural tendency to concentrate on the immediate environment where most perceived threats traditionally arise. Evolutionarily, threats such as predators or hostile forces have typically approached from ground level, reinforcing the instinct to scan horizontally rather than vertically. In a combat situation, the immediate dangers of enemy fire, improvised explosive devices (IEDs), and ambushes from ground-level opponents demand constant vigilance. Soldiers are trained to focus on their surroundings, scan for potential threats in their line of sight, and ensure the safety of their unit from attacks that could come from the front or rear. This horizontal focus is a deeply ingrained survival mechanism, emphasizing the need to address the most apparent and immediate threats first.

Moreover, the stress and intensity of combat can narrow a soldier's field of attention. Under pressure, individuals often experience tunnel vision, where their focus becomes more limited to what is directly in front of them. This psychological response to stress can make it challenging to maintain awareness of aerial threats, as the brain prioritizes immediate, ground-level dangers over less apparent ones from above. While it is crucial for soldiers to monitor the skies for threats like kamikaze drones, human psychology and the nature of ground combat often compel them to focus on their immediate horizontal environment. Evolutionary instincts, training priorities, and stress-induced tunnel vision all contribute to this focus, highlighting the need for ongoing training and technological support to enhance aerial threat detection on the modern battlefield.

When soldiers fail to detect kamikaze drones, the consequences can be particularly dire due to the nature and purpose of these unmanned aerial vehicles (UAVs). Kamikaze drones, also known as loitering munitions, are designed to hover over an area and strike targets with precision once identified. Failure to detect such drones poses several severe risks. The most immediate threat is their lethal payload; kamikaze drones are engineered to deliver explosive charges directly onto targets, and if soldiers do not notice these drones, they are at high risk of being hit by sudden, deadly strikes. Unlike traditional drones that might gather intelligence, kamikaze drones are built for impact and destruction, leading to potential fatalities and severe injuries among troops.

Detection of kamikaze drones is crucial for activating defensive systems or taking evasive actions. Failure to spot these drones means soldiers cannot employ countermeasures such as electronic jamming, anti-drone defenses, or taking cover, leaving them vulnerable to unanticipated attacks with no time to respond effectively. These strikes can disrupt military operations by destroying critical equipment, vehicles, or infrastructure, halting operations, forcing strategic withdrawals, or necessitating immediate reorganization, thereby impeding mission objectives and operational effectiveness. Moreover, the constant potential for a sudden, deadly strike from above can have a profound psychological effect on soldiers, increasing stress, anxiety, and fear. Over time, this can erode morale, diminish combat readiness, and affect the overall mental health of troops.

Additionally, kamikaze drone strikes often cause severe casualties that require immediate medical attention. The inability to detect these drones increases the likelihood of mass casualties, which can overwhelm medical facilities and strain evacuation efforts, affecting not only the injured but also placing additional burdens on medical and support personnel. Strategically, failing to detect kamikaze drones can lead to simultaneous strikes on multiple targets, causing broader setbacks, including the loss of command and control centers, critical supply lines, and communication hubs, further complicating military operations.

### SUMMARY

Disclosed are a method, system, and apparatus of a skyward facing helmet camera and associated methods with artificial intelligence.

In one aspect, a low profile, concavely curved camera housing includes a skyward facing visual sensor, an artificial intelligence model communicatively coupled with the skyward facing visual sensor, and a responsive device. The skyward facing visual sensor on a top surface of the low profile, concavely curved camera housing captures an ambient sky above a wearer of a helmet (e.g., the helmet may be a simple hat in some use cases). The artificial intelligence model detects an object of interest (e.g., a drone, a bird, a plane, a missile, a satellite, an ambient threat, and a celestial object) appearing above the wearer. The responsive device notifies the wearer when the artificial intelligence model detects the object of interest (e.g., either through a mobile phone notification or a haptic vibration).

The artificial intelligence model may utilize anomaly detection to ignore ambient-sky video or images through a neural network that evaluates what is the expected appearance of the sky under normal conditions as opposed to an anomalous condition when the object of interest is present in the sky. The low profile, concavely curved camera housing may attach on an upper surface of a helmet. An attachment means may be by way of a hook and loop method that permits the wearer to reposition the low profile, concavely curved camera housing on other parts of the helmet and/or on a tactical vest worn by the wearer. The responsive device may be a haptic sensor on any one of the helmet and/or the tactical vest of the wearer.

An array of visual sensors may be found on different sides of the low profile, concavely curved camera housing to provide 360 degree situational awareness to the wearer when an ambient threat is detected using the artificial intelligence model.

The low profile, concavely curved camera housing may utilize the artificial intelligence model to differentiate a bird from a loitering munition, and to classify the loitering munition as at least one of a friendly drone and a hostile drone. The responsive device may notify the wearer only when the object of interest is a hostile drone. The responsive device may provide haptic feedback to indicate a source, an azimuth, an elevation, and/or a proximity of an imminent drone attack. A multistatic radar on the tactical vest of the wearer may detect the loitering munition. A command center may direct a series of counter measures to neutralize the hostile drone in the imminent drone attack. The artificial intelligence model may differentiate the hostile drone from another object, such as a bird and/or a plane based on size, speed, a flight pattern, a visual characteristic, a heat characteristic, an electro-magnetic characteristic and/or an acoustic characteristic.

The artificial intelligence model may identify a drone type, a model, and/or a potentially of its payload of the hostile drone in the imminent drone attack by comparing sensor data against databases of known drone signatures to assess a level of threat, classify the drone type, the model, and/or the potentially of its payload of the hostile drone and/or to decide on an appropriate response.

A counter-drone response system of the command center may control an electronic warfare tool, such as a RF jammer and/or a spoofer to disrupt a communication system and/or a navigation system of the hostile drone forcing it to at least one land and/or return to its point of origin. The low profile, concavely curved camera housing may employ AI systems to continuously learn from encounters during imminent attacks, improving detection, identification, and/or interception capabilities of the loitering munition over time.

In another aspect, a counter-UAS (Unmanned Aircraft System) includes a skyward facing visual sensor on a top surface of a low profile, concavely curved camera housing, an artificial intelligence model communicatively coupled with the skyward facing visual sensor, and personal protective equipment. The skyward facing visual sensor captures an ambient sky above a wearer of a helmet. The artificial intelligence model detects a loitering munition and/or a bird. The personal protective equipment having a responsive device integrated in the tactical gear and/or a helmet haptically notifies the wearer when the artificial intelligence model detects a hostile drone approaching a location having a blast radius of the wearer of the personal protective equipment.

The counter-UAS (Unmanned Aircraft System) may further include a sensor system communicatively coupled with the personal protective equipment. The sensor system may employ a sensor to include any of a radar, a radio frequency (RF) scanner, an acoustic sensor, and/or an optical camera to detect a presence of the hostile drone approaching the location having the blast radius of the wearer of the personal protective equipment.

The counter-UAS (Unmanned Aircraft System) may further include a counter-drone response system of the personal protective equipment and/or a command center to control an electronic warfare tool, such as a RF jammer and/or a spoofer, to disrupt a communication system and/or a navigation system of the hostile drone in the imminent attack, forcing it to at least one land and/or return to its point of origin. The counter-UAS (Unmanned Aircraft System) may further include an anti-swarm module of the personal protective equipment and/or the command center to track and neutralize multiple hostile drones simultaneously. The sensor system may deploy a cope cage on a vehicle, an infrastructure, and/or the wearer of the tactical gear.

In yet another aspect, a wearable device includes a responsive device to haptically notify a wearer of the tactical gear when a skyward facing visual sensor sees an object of interest. In addition, the personal protective equipment includes an artificial intelligence model to utilize sky canceling machine learning to ignore a sky through a neural network that evaluates what an appearance is of an expected sky in a normal condition as opposed to an anomalous condition when the object of interest is present in the sky surrounding the wearer and within view of the skyward facing visual sensor.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a system view of a camera housing a helmet with a skyward facing visual sensor and a responsive device on a wearer, according to one embodiment.

FIG. 2 is a conceptual view of a sky cancelation and classification operation based on visual observation of the skyward facing visual sensor, according to one embodiment.

FIG. 3 is a perspective view of an alternative embodiment of the camera housing having visual sensors on all time to detect an ambient threat, according to one embodiment.

FIG. 4 is a blast radius view that alerts the wearer when the skyward facing visual sensor detects the hostile drone and/or an ambient threat, according to one embodiment.

FIG. 5 is a system interaction view that visually represents the intricate process of developing and implementing generative AI models within the personal protective equipment of FIG. 1, according to one embodiment.

FIG. 6 illustrates the innovative application of “Generative AI in Personal Protective Equipment Management using an Integrated Threat Detection Model,” as conceptualized in one embodiment of the of FIG. 1, according to one embodiment.

FIG. 7 is a user interface view of a generative AI model illustrating an exemplary layout depicting a detailed summary of a hostile drone identified by the sensor system of the helmet of FIG. 1, according to one embodiment.

FIG. 8 is a conceptual view of a birdwatching detection system of the helmet based on visual observation of the skyward facing visual sensor of FIG. 1, according to an alternative embodiment.

FIG. 9 is a conceptual view of an astronomy system of the helmet based on visual observation of the skyward facing visual sensor of FIG. 1, according to an alternative embodiment.

Other features of the present embodiments will be apparent from the accompanying drawings and from the detailed description that follows.

### DETAILED DESCRIPTION

Disclosed are a method, system, and apparatus of a skyward facing helmet camera and associated methods with artificial intelligence.

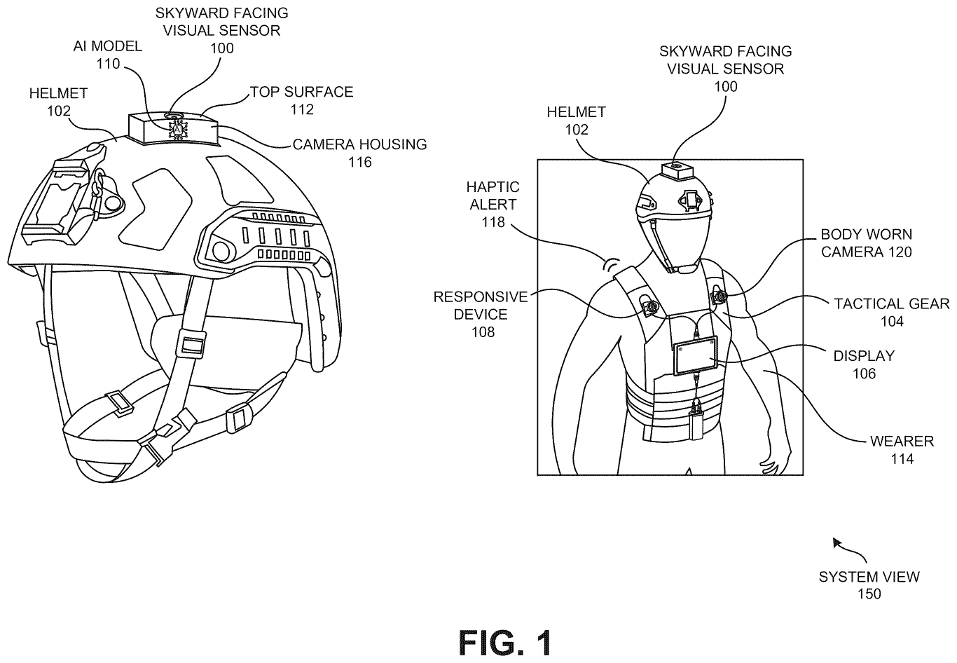

FIG. 1 is a system view 150 of a camera housing 116 on a helmet 102 with a skyward facing visual sensor 100 and a responsive device 108 on a wearer 114, according to one embodiment. FIG. 1 shows a skyward facing visual sensor 100, a helmet 102, a tactical gear 104, a display 106, a responsive device 108, an artificial intelligence model 110, and a top surface 112 of a camera housing 116 on which the skyward facing visual sensor 100 is located, according to one embodiment.

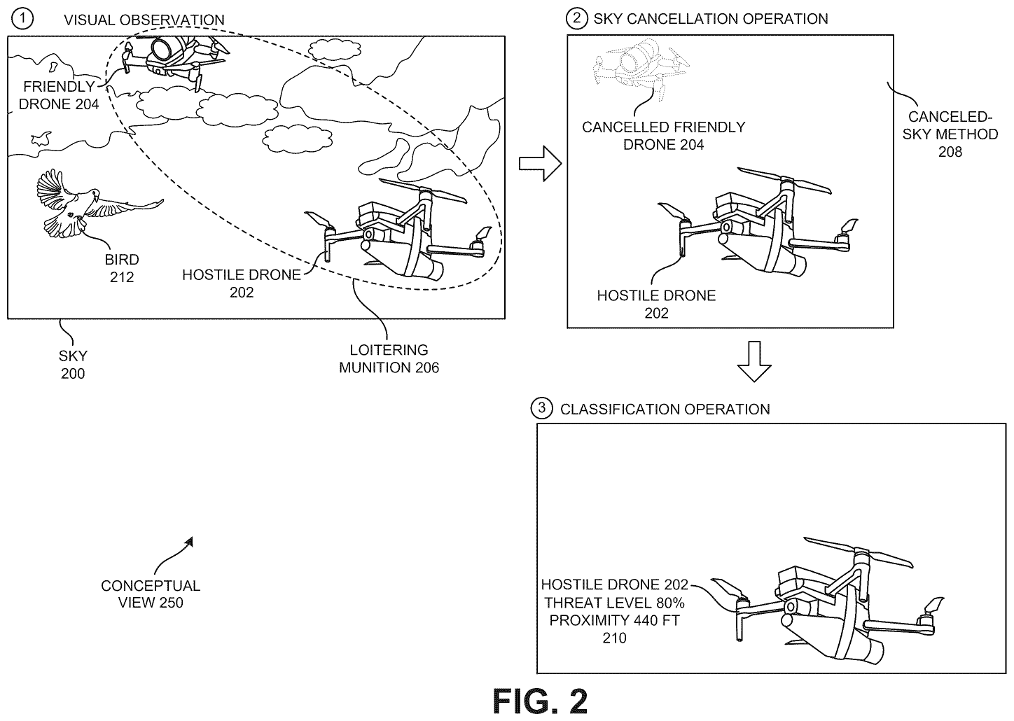

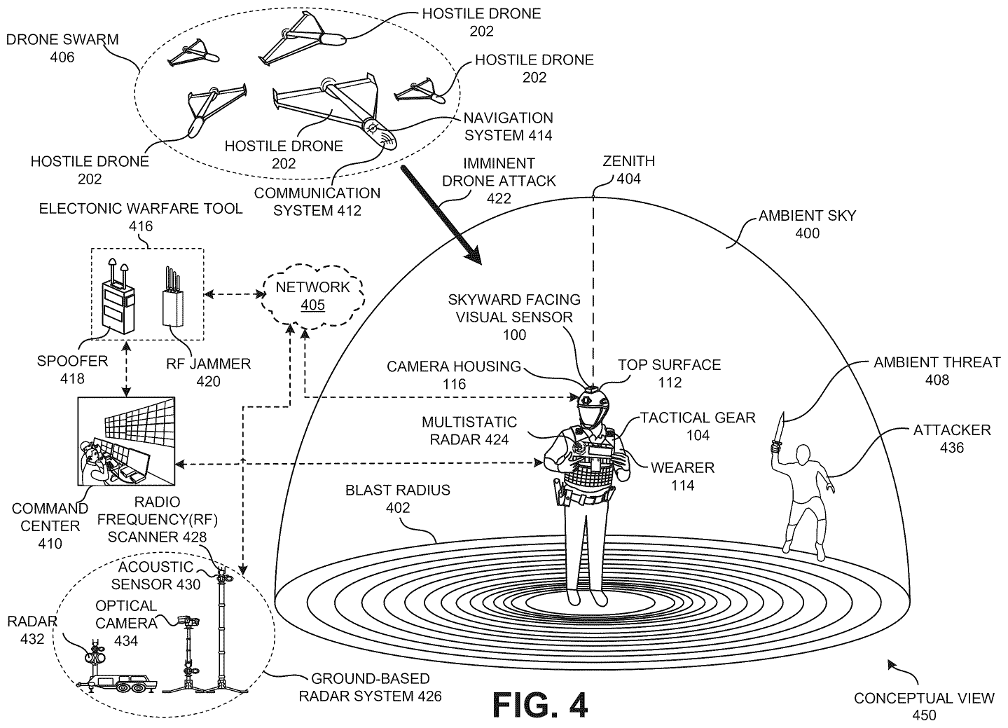

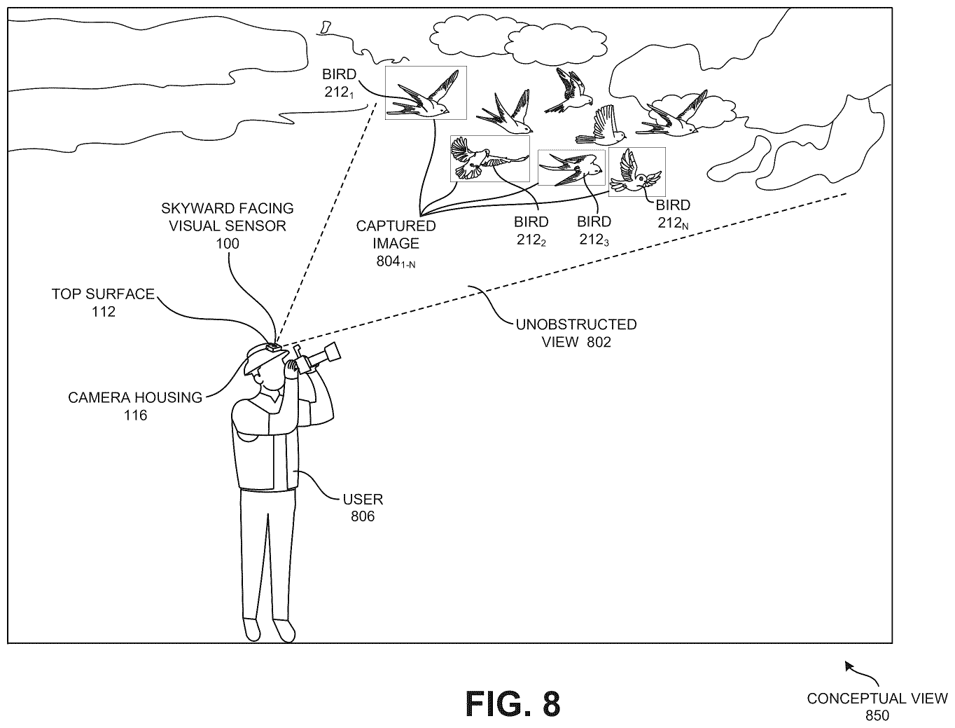

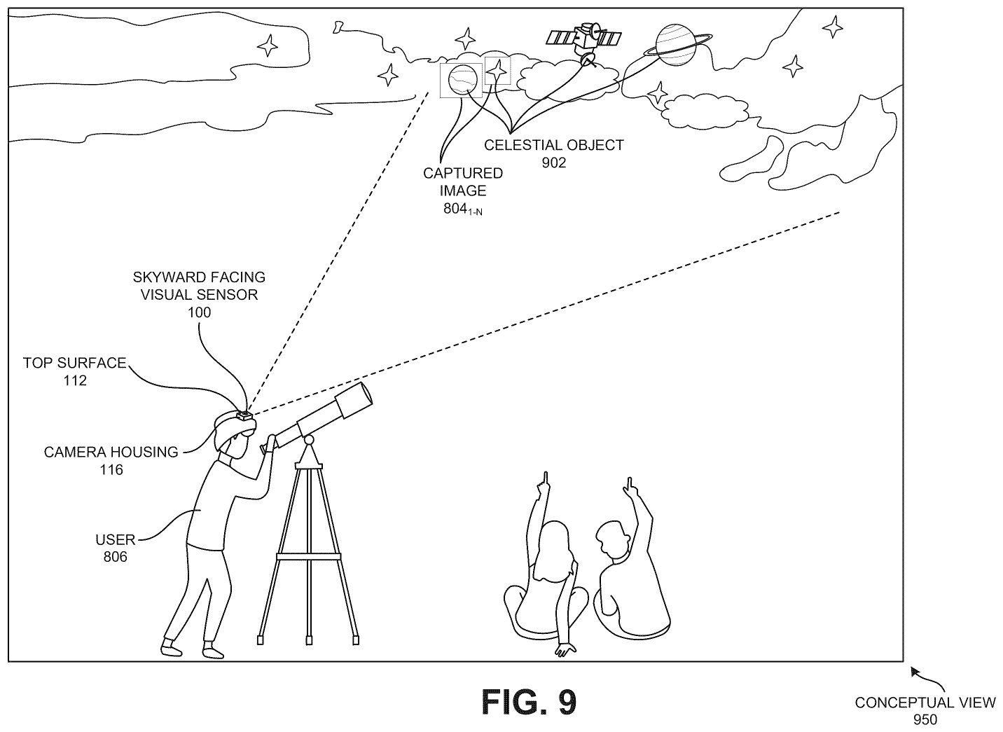

In one embodiment, a low profile, concavely curved camera housing 116 includes a skyward facing visual sensor 100, an artificial intelligence model 110 communicatively coupled with the skyward facing visual sensor 100, and a responsive device 108. The skyward facing visual sensor 100 on a top surface 112 of the low profile, concavely curved camera housing 116 captures an ambient sky 400 above a wearer 114 of a tactical gear 104. The artificial intelligence model 110 detects an object of interest (e.g., a hostile drone 202, a bird 212, a plane, a missile, a satellite, an ambient threat 408, and a celestial object 902). For example, the object of interest may be a loitering munition 206 (a hostile drone 202 in FIG. 2 and FIG. 4), a bird 212 (as described in FIGS. 2 and 8), an ambient threat 408, and/or a celestial object 902 (as described in FIG. 9) appearing above the wearer 114. The responsive device 108 may notify the wearer 114 (e.g., haptically or through a mobile app) when the artificial intelligence model 110 detects the object of interest, according to one embodiment.

The skyward facing visual sensor 100 may be a high resolution, wide angle camera capturing a maximum amount of a sky above a wearer (e.g., the wearer may be a civilian or a soldier). The helmet 102 and/or the tactical gear 104 may include optional infrared, thermal, night vision, or audio, advanced visual, motion, and/or radar (eg, multistatic radar) sensors that seek to detect unfriendly drones that the human eye may have difficulty in perceiving or detecting. The skyward facing visual sensor 100 may include high-resolution cameras equipped with both optical and infrared capabilities to ensure clear vision and object detection under various environmental conditions, including low light or adverse weather. The skyward facing visual sensor 100 may be positioned to constantly monitor the sky, detecting flying objects with high precision due to its upward orientation. Additional sensors, such as LIDAR or radar, may be integrated within the skyward facing visual sensor 100 to enhance detection capabilities and provide depth information for more accurate object assessment, according to one embodiment.

The helmet 102 may be a protective head covering made of a hard material to resist impact. The helmet 102 may be a simple hat (e.g., baseball cap) if used by civilians and/or a protective headgear if used in public safety or in the military. The helmet 102 may be a critical piece of personal protective equipment designed to provide head protection, communication, and technological integration for military personnel, law enforcement officers, and other security operators. The helmet 102 may be engineered to meet specific safety standards and are equipped with advanced features to enhance operational effectiveness and situational awareness. The helmet 102 may be paired with other tactical equipment (e.g., tactical gear 104, responsive device 108, etc.) or communication networks, enabling data sharing and coordination. This pairing (wired or wireless, preferably wired for no electronic signature) may allow for broader situational awareness and operational coordination with other units or command centers, and extended battery life through battery units on the person. In one embodiment, a solar array may power the skyward facing visual sensor 100. The helmet 102 may be equipped with heads-up displays (HUDs) that provide real-time data, navigation, and other informational overlays to enhance situational awareness, according to one embodiment.

The tactical gear 104 may be any wearable torso covering apparel designed for military and/or law enforcement purposes to enhance the efficiency, safety, and capability of the wearer 114 during operations, such as a tactical vest or a tactical carrier. Tactical gear 104, encompassing tactical vests, inner vests, and carriers, may include a wide range of equipment designed for military, law enforcement, and security personnel, and for civilian use in certain contexts like hunting, shooting sports, and outdoor activities. It should be understood that while a tactical vest 104 is illustrated, it may very well just be any regular t-shirt if used by civilian use cases. Tactical vest embodiments of tactical gear 104 may be designed to carry essential gear and provide quick access to ammunition, communications devices, and medical kits, and may have multiple pockets and pouches for organization, according to one embodiment. Tactical carrier embodiments of tactical gear 104 may be plate carriers specifically designed to hold ballistic armor plates for protection against bullets and shrapnel, and may also carry additional gear, according to one embodiment. Tactical gear 104 may also include body armor including stab-proof vests, bulletproof vests and/or other garments (worn inside a uniform or outside a uniform) designed to protect against ballistic and/or sharp object threats. In one embodiment, tactical gear 104 may include ghillie suits and camo netting for blending into the environment during surveillance and/or hunting. In an alternative embodiment, the tactical gear 104 may not have ballistic, stab-proof, or bullet proof protection, but may be a simple garment having the various haptic and visual sensors (e.g., array of visual sensors, array of haptic sensors, etc.) described herein.

By providing immediate, intuitive feedback directly to the wearer's body, the tactical gear 104 may allow the wearer to react swiftly and appropriately to potential threats, even in situations where their visual attention may be compromised or directed elsewhere. This system may enhance situational awareness and decision-making capabilities, fundamentally improving the safety and operational efficiency of officers in the field, according to one embodiment. Incorporating technology to detect and interpret these approaching indicators may enhance the safety of law enforcement personnel by providing them with actionable intelligence, thus reducing the likelihood of physical confrontations and enhancing the overall effectiveness of field operations, according to one embodiment. The tactical gear 104, integrated with the advanced skyward facing visual sensor 100 and AI capabilities, may be designed to enhance the detection and response to various aerial threat situations, according to one embodiment.

The display 106 may be an electronic device positioned onto the tactical gear 104 for the visual presentation of data or images captured by the skyward facing visual sensor 100. The display 106 may be a Juggernaut® body worn mobile device having a display 106, which folds downward from a front chest area of the wearer 114 and may be utilized for providing detailed information which might include maps, full messages, and situational updates. The display 106 may provide real-time access to critical operational data, including live video feeds, tactical maps, and surveillance output from the skyward facing visual sensor 100 to the wearer 114. This information may be crucial for making informed decisions quickly, according to one embodiment.

Some tactical gear 104 may include HUDs in eyewear or visors, providing visual notifications directly in the wearer's line of sight. Based on the analysis of the captured data from the skyward facing visual sensor 100 by the artificial intelligence model 110, the system may generate a threat level indicator, which is visualized on the display 106 of the tactical gear 104. Security personnel equipped with the system may receive discreet notifications through their tactical gear 104, possibly via haptic alert 118 or through a heads-up display (HUD) showing the location and basic information about the loitering munition 206 identified by the AI model 110, according to one embodiment.

The tactical gear 104 may be equipped with a responsive device 108, which includes capabilities to sense various forms of threats, such as ambient threat based on analysis of the captured data from the skyward facing visual sensor 100. The responsive device 108 may include haptic sensors that may vibrate when the skyward facing visual sensor 100, and/or an array 350 of visual sensors that encompass all sides of the camera housing 116 as illustrated in FIG. 4 detect the ambient threat 408 to the wearer 114 of the tactical gear 104. The responsive device 108 may be interconnected, likely through a secure, low-latency network that allows for real-time data processing and analysis. The responsive device 108 may notify the wearer 114 of the tactical gear 104 when the skyward facing visual sensor 100 identifies a threat to the wearer 114, according to one embodiment.

Approaching Indicators/Visual Cues that may cause the responsive device 108 to vibrate when the skyward facing visual sensor 100, and/or an array 350 of visual sensors detects the ambient threat 408 may include:

Hands in the Pocket Approaching: An individual (e.g., attacker 436) approaching with hands in pockets may be concealing a weapon or preparing to deploy it, according to one embodiment. This behavior may warrant caution and preparedness for a quick defensive response, according to one embodiment.

Facial Expressions: Expressions such as pressing lips together, jaw crunching, and squinting eyes may often indicate stress, determination, or aggression, according to one embodiment. Observing these may signal an officer (e.g., wearer 114) to the heightened emotional state of the individual, potentially leading to aggressive actions, according to one embodiment.

Disgust, Anger, Frustration: These emotional displays may escalate to physical confrontation, according to one embodiment. Recognizing these emotions allows officers (e.g., wearer 114) to deploy de-escalation techniques early, according to one embodiment.

Pupil Dilation: Often a physiological response to emotional arousal, fear, or intention to be aggressive, dilated pupils may serve as a cue to the officer (e.g., wearer 114) about the individual's heightened state of alertness or aggression, according to one embodiment.

Making Their Hand into a first 132A: This is a preparatory gesture for a physical attack (e.g., ambient threat 408) and may serve as a clear warning sign of potential aggression, according to one embodiment.

Scanning: When an individual (e.g., attacker 436) alternately walks toward and away from an officer (e.g., wearer 114) while scanning the surroundings, it may indicate planning an escape route or assessing the environment for an advantage in a potential confrontation, according to one embodiment.

Body Angling: An individual (e.g., attacker 436) angling their body towards an officer (e.g., wearer 114) may be positioning themselves for a physical altercation or to gain leverage in an attack (e.g., called “blading,” it can also be an indicator that a person is armed), according to one embodiment.

Raising Shoulder and Chest, Stretching Exercises: These actions may indicate an individual (e.g. attacker 436) is psyching themselves up for a confrontation, increasing their physical presence or preparing their body for a fight, according to one embodiment.

Looking Foot to Head (Sizing Up the Cop): This visual scanning may often be used to assess an officer's physical capabilities, vulnerabilities, and equipment, possibly in preparation for a confrontation, according to one embodiment.

Looking Left and Right: This behavior may indicate nervousness, looking for escape routes, or seeking the presence of law enforcement backups or witnesses before engaging in a confrontational act, according to one embodiment.

Sudden Change in Voice Pitch or Volume: An abrupt change in the tone or loudness of a person's voice may indicate stress, anger, or imminent aggression, according to one embodiment. Higher pitch and louder volume often signal an escalation in emotional intensity, according to one embodiment.

Excessive Sweating: While this may be attributed to various factors, in a confrontational or high-stress situation, excessive sweating may indicate nervousness, stress, or fear, potentially signaling that an individual (e.g., attacker 436) is preparing for aggressive action, according to one embodiment.

Rapid Breathing: This physiological response may signify anxiety, fear, or aggression. Observing an increase in someone's breathing rate may indicate a heightened emotional state or preparation for physical exertion, according to one embodiment.

Avoiding Eye Contact or Intense Staring: Either avoiding eye contact entirely or engaging in prolonged, intense staring may be indicators of aggression, according to one embodiment. The former may signal a desire to hide intentions, while the latter can be an attempt to intimidate, according to one embodiment.

Exaggerated Yawning or Stretching: While seemingly innocuous, these behaviors in certain contexts may be a way to display dominance, prepare physically for action, or mask nervousness, according to one embodiment.

Tapping Feet or Fidgeting: Signals restlessness or impatience, which, in confrontational scenarios, may indicate a buildup of aggressive energy or a readiness to act, according to one embodiment.

Repeated Touching of Face or Head: This nervous habit may signal lying, anxiety, or stress, potentially indicating that an individual (e.g., attacker 436) is uncomfortable with the situation and may be considering escalation, according to one embodiment.

Clenching Jaw or Grinding Teeth: Beyond being a sign of stress or anger, this may also be a preparatory action for physical confrontation, signifying that an individual (e.g., attacker 436) is bracing for aggression, according to one embodiment.

Abrupt Movements or Changes in Posture: Sudden, jerky movements or quickly changing posture may indicate that an individual (e.g., attacker 436) is gearing up for aggressive actions or trying to assert dominance, according to one embodiment.

Mirroring Officer Movements: If an individual (e.g., attacker 436) begins to subtly mimic the movements of an officer, it may be a sign of attempted intimidation or preparation for a physical altercation (e.g., ambient threat 408), according to one embodiment.

Concealing One Side of the Body or Shuffling: This behavior may indicate that an individual (e.g., attacker 436) is concealing a weapon on their person and is possibly positioning themselves to use it, according to one embodiment, according to one embodiment.

Excessive Swearing or Threatening Language: Verbal cues may also serve as indicators of aggression, according to one embodiment. An increase in swearing, threats, or hostile language may signal an escalation towards physical confrontation, according to one embodiment.

Adjusting Clothing or Accessories Frequently: This behavior may indicate nervousness or the concealment of weapons or contraband, according to one embodiment. Frequent adjustments may be a pretext to reach for a concealed item, according to one embodiment.

Foot Tapping or Shifting Weight from One Foot to Another: Signs of impatience, nervousness, or preparing to sprint or move quickly, possibly to initiate an attack or flee, according to one embodiment.

Covering Mouth or Touching Face: Often a sign of deception or nervousness, according to one embodiment. When coupled with other indicators, it may suggest an intent to mislead or hide true intentions, according to one embodiment.

Crossed Arms with Tense Muscles: While sometimes a sign of mere discomfort or self-soothing, in certain contexts, it may indicate defensiveness or resistance to engagement, signaling a potential for escalation if approached, according to one embodiment.

Unusual Posture Adjustments: Sudden or exaggerated adjustments in posture, such as puffing up the chest or overly straightening the back, may be attempts to appear more dominant or intimidating, according to one embodiment.

Physiological Response: The system may utilize thermal imaging cameras (e.g., body worn camera 120) and infrared sensors (e.g., left side facing visual sensor 302, right side facing visual sensor 304, back facing visual sensor 306, front facing visual sensor 306, skyward facing visual sensor 100, etc.) integrated into the helmet 102 and/or tactical gear 104 to capture subtle changes in body temperature and perspiration levels of individuals within a monitored area, according to one embodiment. These sensors may be sensitive enough to detect increased heat emissions and visible signs of sweating, which are physiological indicators of elevated heart rates and potential pre-assaultive behavior or medical emergency, according to one embodiment. The core of this system may be an AI model 110 (e.g., a compute model) trained in computer vision techniques to interpret the data collected by thermal and infrared sensors accurately, according to one embodiment. This AI model 110 may analyze patterns of heat and perspiration to distinguish between normal, non-threatening physiological states and those that might precede aggressive actions or be correlated to a heart attack requiring immediate medical attention, according to one embodiment. Upon detecting an attacker 436 exhibiting signs of elevated heat emission and perspiration indicative of a potential threat and/or medical emergency, the system may automatically classify the individual as the attacker 436 of interest or requiring medical attention and triggers an alert, according to one embodiment. Security personnel equipped with the system may receive discreet notifications through their tactical gear 104, possibly via haptic feedback or through a heads-up display (HUD) showing the location and basic information about the individual identified by the AI model 110, according to one embodiment. The system may guide responding wearer 114 with recommended approaches or interventions, leveraging historical data and predictive modeling to suggest actions that minimize the risk of escalation, according to one embodiment.

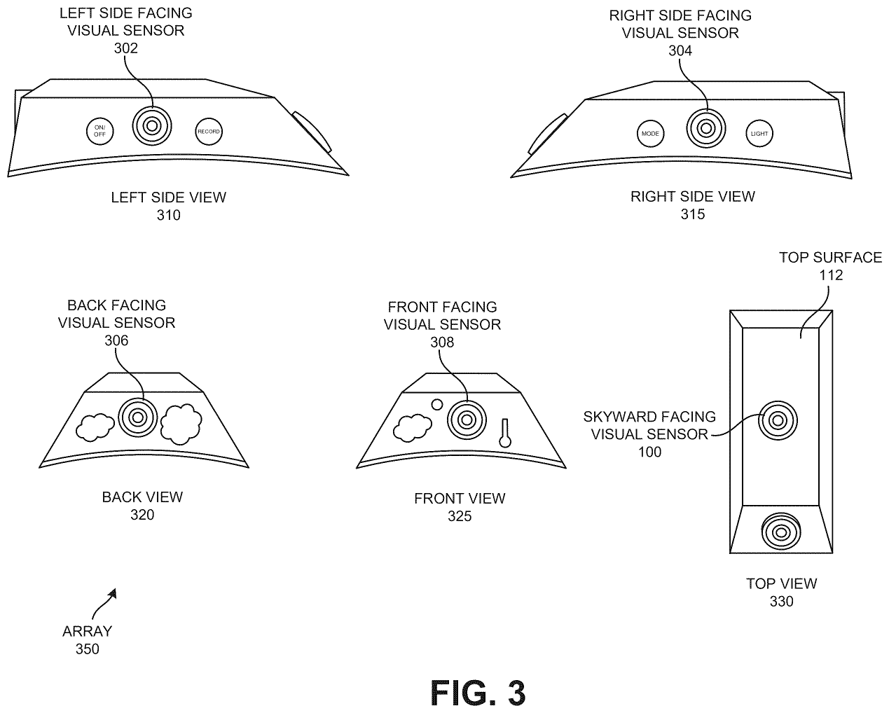

The helmet 102, including the integration of visual sensor array 350 of FIG. 3 and artificial intelligence, may assist officers in recognizing and responding to these cues, according to one embodiment. Visual sensors of FIG. 3 on all sides of the camera housing 116 equipped with advanced sensors may detect subtle physiological and behavioral indicators from a distance, providing officers with an additional layer of situational awareness. Artificial intelligence may analyze these cues in real-time, alerting the wearer 114 through haptic feedback or visual signals on their tactical gear 104 or associated displays 106, according to one embodiment. This advanced warning system may allow officers to adjust their stance, call for backup, initiate de-escalation protocols, or prepare for defensive measures as needed, according to one embodiment.

Incorporating the detection of precursors to potentially aggressive or evasive actions into the functionality of a tactical gear 104 may involve leveraging a combination of sensors and AI-driven analysis to interpret human behavior and bodily cues in real-time, according to one embodiment. The tactical gear 104, equipped with advanced technology, may analyze these precursors and provide haptic feedback to the wearer 114, thereby alerting them to potential threats before they fully manifest, according to one embodiment.

### Detection of Precursors:

Pick Up the Pants or Tie Up Their Laces: The tactical gear sensors (e.g., responsive device 108, visual sensors of FIG. 3, etc.), potentially including visual or motion sensors integrated with UAV support, may detect sudden movements or specific gestures associated with preparing to run or engage in physical conflict, according to one embodiment. These actions, such as adjusting one's pants or tying shoelaces, are analyzed by the vest's onboard AI model 110 to determine their context and potential threat level, according to one embodiment.

21-Foot Rule Awareness: The tactical gear 104 system may incorporate training data on the 21-foot rule, enabling it to gauge the distance between the officer (e.g., wearer 114) and an individual (e.g., attacker 436) armed with a knife, shank, or similar weapon, according to one embodiment. Utilizing GPS module, motion sensors (e.g., responsive device 108, visual sensors of FIG. 3, etc.), and possibly LIDAR technology (e.g., using multistatic radar 424 and ground based radar system 426 of FIG. 4, etc.), the system may accurately measure distances in real-time, alerting the officer when someone enters this critical range, thereby increasing their risk, according to one embodiment.

Removing Footwear: Similar to detecting adjustments in clothing, the tactical gear 104 and/or helmet 102 system may recognize motions or posture changes indicative of a person removing high heels or sandals, interpreted as preparations for a confrontation or flight, according to one embodiment. This may be detected through a combination of visual recognition technologies and movement analysis algorithms, according to one embodiment.

Sudden Stop in Movement: The tactical gear 104 sensors may detect when an individual (e.g., attacker 436) who has been moving erratically suddenly stops, which might indicate a decision point or preparation for an aggressive action, according to one embodiment.

Rapid Eye Movement or Blink Rate: Utilizing facial recognition or eye-tracking technology, the system may interpret increased blink rates or rapid eye movement as signs of stress, deception, or the intent to initiate an aggressive action, according to one embodiment.

Hand Gestures Towards Waistband or Jacket: Movements towards areas where weapons are commonly concealed may be detected by visual sensors of FIG. 3 on the helmet 102, indicating a potential draw of a weapon, according to one embodiment.

Sudden Group Convergence: The detection of multiple individuals suddenly converging on a location may indicate a coordinated action or ambush, according to one embodiment. This may be detected through motion sensors of FIG. 3 on the helmet 102 and/or tactical gear 104 and AI analysis of crowd behavior, according to one embodiment.

Change in Vocal Tonality Detected by Audio Sensors: The integration of audio sensors may allow the system to detect changes in vocal pitch, volume, or tone that often accompany aggressive intent or heightened stress, according to one embodiment.

Abnormal Breathing Patterns: Through sound analysis or body sensors on tactical gear 104 or the UAVs 136, the system may detect changes in breathing patterns that may indicate stress, fear, or preparation for physical exertion, according to one embodiment.

Quick Repeated Glancing in a Specific Direction: Indicative of looking for escape routes or the arrival of accomplices, detected through motion or visual sensors of FIG. 3 on the helmet 102 by analyzing head movements, according to one embodiment.

Rapid Dismount from a Vehicle: Sudden movements associated with exiting a vehicle quickly, which may be detected by a combination of visual and motion sensors, indicating a potential for immediate confrontation or flight, according to one embodiment.

Unusual Posture Adjustments: Detecting through visual sensors of FIG. 3 on the helmet 102, signs of someone adjusting their stance in a way that is common before initiating a physical attack or running, according to one embodiment.

Discrete Signaling Between Individuals: Recognizing subtle signals or gestures between individuals that may indicate coordination or premeditation of an aggressive action, according to one embodiment.

Crowd Noise Analysis: The AI system of the helmet 102 is designed to recognize shifts in crowd noise that may indicate distress, panic, or the onset of a potentially dangerous situation, according to one embodiment. By analyzing patterns in sound level, frequency, and disruption within ambient noise, the AI may identify anomalies that precede incidents, allowing for preemptive action, according to one embodiment.

Keyword Detection in Multiple Languages: Recognizing the diverse linguistic landscape of urban cities, the AI model 110 is programmed to detect keywords or phrases in various languages that may signify a threat or call for help, according to one embodiment. This feature may particularly be useful traffic stops or drug raids, enabling them to pick up spoken cues, according to one embodiment. Integrated into the officer's gear, this module may capture spoken language in the vicinity of the officer (e.g., wearer 114), leveraging directional microphones to focus on specific sources of speech, such as an attacker 436 or group of individuals (e.g., number of persons), according to one embodiment. This engine may process the captured audio in real-time (e.g., optionally translating it to the officer's preferred language) and analyze it for specific keywords or phrases known to be pre-assault indicators or threats, according to one embodiment. This analysis relies on an extensive, dynamically updated database of terms and phrases associated with aggressive behavior or intent across multiple languages, according to one embodiment.

Upon detection of specific keywords or phrases indicating imminent threat, the system may immediately alert the officer (e.g., wearer 114) through visual, haptic and/or auditory signals on their personal device or the tactical gear's heads-up display, according to one embodiment. Key phrases or threats detected may be relayed back to a command center 410 or support units in real-time, providing them with situational awareness and the ability to respond appropriately, including dispatching additional resources or guidance, according to one embodiment. All translated conversations and identified keywords/phrases are automatically documented and timestamped (e.g., using real-time data), providing invaluable evidence for later analysis, reporting, or legal proceedings, according to one embodiment. By identifying potential threats before they escalate into physical actions, officers can take preventative measures, increasing their safety and the safety of bystanders, according to one embodiment. The ability to understand and analyze any language in real-time may help the officers to overcome language barriers, ensuring that suspects cannot exploit language differences to their advantage, according to one embodiment.

Prior Assaultive Conduct: Historical data from previous police encounters to inform the real-time evaluation of potential threats when the tactical gear 104 interfaces with Computer-Aided Dispatch (CAD), Records Management Systems (RMS), and other relevant criminal databases, according to one embodiment. This component may establish secure, real-time access to CAD, RMS, and other pertinent databases, according to one embodiment. It may retrieve data related to the individuals (e.g., attacker 436) currently being interacted with or observed, focusing on their history of violence, resistance to arrest, possession or use of weapons, and other relevant factors, according to one embodiment. By leveraging AI and machine learning, the engine may analyze historical data along with real-time inputs (including the translated conversations and identified verbal pre-assault indicators) to assess the potential threat levels, according to one embodiment. The engine may consider patterns of behavior, the context of previous encounters, and any notes indicating a propensity for violences, according to one embodiment. Based on the analysis, the system may generate a threat level indicator, which is visualized on the display 106 of the tactical gear 104, the officer's heads-up display or another accessible interface, according to one embodiment. This indicator may provide a quick, understandable reference that combines historical data insights with real-time situational awareness, according to one embodiment.

When the system identifies an individual with a significant history of violence or resistance, it may alert the wearer 114 with a personalized threat level indicator. This alert may include a brief summary (e.g., using AI summary) of relevant historical data, enabling the officer to approach the situation with appropriate caution and tactics, according to one embodiment. Depending on the assessed threat level, the system may suggest tailored response protocols, ranging from calling for backup to deploying non-lethal measures preemptively, according to one embodiment. These protocols may be dynamically adjusted based on the ongoing situation and any new information gathered, according to one embodiment. All interactions, threat assessments, and responses may be automatically documented within the system, including the rationale for the threat level assigned, according to one embodiment. This documentation may be invaluable for post-incident analysis, training, and legal proceedings, according to one embodiment. The system may incorporate a feedback mechanism, allowing the wearer 114 to provide input on the accuracy and usefulness of the threat assessments, according to one embodiment. This feedback may be used to continuously refine the analytics algorithms, improving the system's effectiveness over time, according to one embodiment.

### Implementation and Operation of the Embodiments of Helmet 102 and the Tactical Gear 104 are Described Below:

Integration with Aerial and Ground Systems: The sound and language identification capabilities may be integrated into both tactical gear 104 and helmet 102, according to one embodiment. Drones flying over events or crowded areas may capture audio, which is then processed in real-time by the AI to identify potential threats or distress signals, according to one embodiment.

Real-time Alerts and Response Coordination: Upon detecting a significant sound pattern or keyword, the tactical gear 104 system may generate alerts (e.g., haptic alert 118) that are communicated to the security team, according to one embodiment. The alerts may be specific, indicating the nature of the detected anomaly and its location, enabling targeted responses. For example, if the AI identifies the sound pattern of a crowd suddenly running or keywords associated with a fight, security personnel may quickly mobilize to the exact location, according to one embodiment.

Gait Pattern Recognition: Utilizing the visual sensors already incorporated into tactical gear 104 or the UAVs, the system may employ advanced algorithms to analyze the gait patterns of individuals during specific security scenarios, according to one embodiment. This analysis may focus on identifying deviations from normal gait patterns that can suggest the concealment of a weapon, such as stiffness in one leg, asymmetric arm swings, or other indicators of hidden objects, according to one embodiment.

Unique Gait Signatures: Beyond threat detection, gait analysis may also be employed as a form of biometric identification, according to one embodiment. Each person's gait is unique, and by capturing and analyzing these gait patterns, the system may identify individuals based on their movement alone, according to one embodiment. This feature may be particularly useful for tracking known individuals of interest without relying on facial recognition or other more invasive identification methods, according to one embodiment.

Communications during a Foot Pursuit: In an innovative embodiment designed to address the challenges of foot pursuits in law enforcement and security operations, a specialized drone system may be integrated to serve as a communication link between law enforcement and suspects, according to one embodiment. A special purpose UAV equipped with communication capabilities, may be deployed to engage with a suspect actively attempting to flee on foot, according to one embodiment. The system may aim to safely manage the pursuit, offering commands or negotiations aimed at de-escalating the situation without direct physical confrontation initially, according to one embodiment.

The drone (e.g., UAV) may be equipped with a loudspeaker and microphone, enabling two-way communication between the officer (e.g., wearer 114) and the suspect (e.g., attacker 436), according to one embodiment. This system may enable officers or commanders at headquarters to issue commands, warnings, or negotiate with the suspect in an attempt to de-escalate the situation and encourage peaceful surrender, according to one embodiment. Understanding the importance of tone and language in negotiation, the drone's AI may adapt its communication style based on the suspect's responses, background information, or predefined protocols to increase the chances of compliance, according to one embodiment. The drone may be designed to be non-intimidating, using visual signals such as blinking lights to communicate its purpose as a communication tool rather than a surveillance or attack drone, according to one embodiment. This approach may aim to reduce the suspect's stress and potential for violent reaction, according to one embodiment. The drone (e.g., UAV) may be designed to function in various operational modes described below:

Officer to Suspect Communication: In scenarios where the pursuing officer needs to issue commands or warnings to the suspect but is physically unable to due to the intensity of the pursuit, the officer may communicate through the drone, according to one embodiment. The officer's message may be relayed via a control device, such as a headset or a wearable interface (e.g., display 106) integrated into their tactical gear 104, and broadcasted through the drone's loudspeaker (e.g., megaphone), according to one embodiment.

Command Center to Suspect Communication: For more strategic communication, or in cases where negotiation might be necessary, the command center 410 may take over the communication process, according to one embodiment. Specialists or negotiators may use the drone as a proxy to communicate directly with the suspect, offering instructions, warnings, or attempting to de-escalate the situation remotely, according to one embodiment.

Haptic Response Mechanism: Upon detecting these precursors, the tactical gear 104 AI system may trigger a haptic response (e.g., haptic alert 118) tailored to the specific nature of the detected precursor, according to one embodiment.

Vibration Patterns: Different vibration patterns may be assigned to various precursors, according to one embodiment. For instance, a rapid pulsing vibration may indicate someone entering the 21-foot danger zone, while a slower, steady vibration can signal preparatory actions for flight or fight, such as adjusting clothing or removing footwear, according to one embodiment.

Intensity and Location of Vibration: The intensity and location of the haptic feedback (e.g., haptic alert 118) on the tactical gear 104 may indicate the urgency and direction of the threat (e.g., ambient threat 408), according to one embodiment. For example, a stronger vibration on the front side of the vest may alert the wearer 114 to a threat directly ahead, according to one embodiment.

Sequential Alerts: If multiple precursors are detected in quick succession, the tactical gear 104 may deliver a series of haptic alerts, enabling the wearer 114 to understand the evolving situation without needing to visually confirm these cues, according to one embodiment.

By providing immediate, intuitive feedback directly to the wearer's body, the tactical gear 104 may allow law enforcement officers to react swiftly and appropriately to potential threats, even in situations where their visual attention may be compromised or directed elsewhere. This system may enhance situational awareness and decision-making capabilities, fundamentally improving the safety and operational efficiency of officers in the field, according to one embodiment. Incorporating technology to detect and interpret these approaching indicators may enhance the safety of law enforcement personnel by providing them with actionable intelligence, thus reducing the likelihood of physical confrontations and enhancing the overall effectiveness of field operations, according to one embodiment. The tactical gear 104, integrated with advanced sensors and AI capabilities, may be designed to enhance the detection and response to various indicators of drug or alcohol impairment during interactions with individuals, according to one embodiment.

### Detection Capabilities:

Shiftiness of the Eyes and Glossy Eyes: Cameras equipped with high-definition and infrared capabilities may detect rapid eye movements and the physical appearance of the eyes, signaling nervousness or substance influence, according to one embodiment. AI algorithms analyze these visual cues to assess potential impairment, according to one embodiment.

Speech Patterns: By employing auditory sensors and advanced natural language processing algorithms, the gear may analyze speech for signs of acceleration, slowness, slurring, or incoherence, according to one embodiment These speech patterns may be crucial indicators of possible drug or alcohol influence, according to one embodiment.

Failure to Multi-task: Responsive device 108 may observe and AI may interpret actions that demonstrate an individual's difficulty in performing simultaneous tasks, a common symptom of impairment, according to one embodiment.

Repetitive or Nonsensical Conversation: The AI system may identify patterns in speech that indicate confusion, disorientation, or an inability to follow the conversation, such as repeating questions or rambling about unrelated topics, according to one embodiment.

Physical Coordination and Movements: Motion sensors and visual analysis may detect abnormal physical behaviors such as slowed actions, imbalance (swaying), or unusual tics, according to one embodiment. These behaviors may be analyzed in the context of the individual's overall movement and interaction with the environment, according to one embodiment.

Open Bottles and Other Paraphernalia Visibility: Visual sensors may identify objects within the vehicle that suggest substance use, such as open bottles, Ziploc bags, or other containers associated with drug use, according to one embodiment.

Upon detecting one or more signs of drug or alcohol impairment, the tactical gear 104 may alert the wearer through haptic feedback mechanisms, providing a non-visual, discreet notification that allows the officer to maintain focus on the individual and the environment, according to one embodiment. The nature of the feedback (e.g., vibration patterns, intensity) may indicate the type of impairment suspected, enabling the officer to adapt their approach accordingly, according to one embodiment. The haptic feedback may provide real-time alerts to officers, enabling quicker adjustments in handling situations involving impaired individuals, potentially reducing risks, according to one embodiment. The discreet nature of haptic alerts may ensure that the officer gains insights without escalating the situation, maintaining a safer interaction dynamic, according to one embodiment. The sensors' data, including video and audio analysis, may be logged as part of the encounter's record, providing valuable evidence for legal proceedings if necessary, according to one embodiment. The AI's analysis and the recorded data from encounters may serve as training material for law enforcement, helping to refine detection techniques and interaction strategies with impaired individuals, according to one embodiment. Incorporating these technologies into tactical gear 104 may not only enhance the officers' ability to detect and respond to signs of drug or alcohol impairment but also contributes to safer, more effective law enforcement practices, according to one embodiment.

The tactical gear 104, designed with advanced detection capabilities and integrated with a comprehensive sensor array, may identify potential gun-related threats through nuanced behavioral and visual cues, according to one embodiment. This detection system may combine motion sensors, visual recognition technology, artificial intelligence (AI), and thermal imaging to interpret actions and physiological signs indicative of a concealed weapon, according to one embodiment.

Detection Mechanisms Integrated within the Tactical Gear 104 May Include:

Body Posture and Movement Analysis: The tactical gear 104 system may utilize motion sensors and AI to analyze body posture and movements, according to one embodiment. Leaning of the non-dominant shoulder towards the police, a movement that may indicate shielding or preparing to draw a weapon, may be detected through these sensors (e.g., responsive device 108), according to one embodiment. The AI may evaluate this movement within the context of the situation to assess threat levels, according to one embodiment.

Visual Recognition Technology: Integrated cameras or visual sensors of the array 350 of FIG. 3, may use AI-driven visual recognition to detect repeated touching or glancing towards areas where weapons are commonly concealed, such as under clothing, within front hand pockets of hoodies, sweaters, or jackets, and in cross-body fanny packs, according to one embodiment.

Thermal Imaging: Concealed weapons, particularly those made of metal, may alter the thermal profile of an individual, according to one embodiment. Thermal sensors may detect unusual heat signatures or the lack thereof between the belly and body or around waist areas where guns are often hidden, providing a clue to the presence of a concealed firearm, according to one embodiment.

Dominant Hand and Access Patterns: The AI system may analyze the positioning of objects and body adjustments that align with dominant hand accessibility, according to one embodiment. This may include observations such as individuals moving the compartment of a cross-body fanny pack for easier access or the detectable slant in clothing caused by the weight of a concealed weapon, according to one embodiment.

Haptic Feedback for Gun Situation Awareness: Upon detecting signals indicative of a concealed weapon, the tactical gear's AI system (e.g., using AI model 110) may trigger a specific haptic response pattern to alert the wearer 114 to the potential threat, according to one embodiment:

Distinct Vibration Patterns: Custom vibration alerts may inform the officer of different threat levels or types of weapon-related behaviors observed, according to one embodiment. For example, a unique pulsating vibration might be used to indicate the detection of an individual adjusting a concealed weapon's position, according to one embodiment.

Directional Alerts: The vest may utilize haptic feedback to indicate the direction of the potential threat, enabling the wearer 114 to focus their attention appropriately without visually confirming the suspect's actions, according to one embodiment.

Urgency Levels: The intensity of the vibration may convey the urgency or immediate threat level, with more intense feedback signaling higher risks, according to one embodiment.

Sequential and Contextual Alerts: If the system detects a combination of precursors, such as body movement followed by touching a concealed area, it may provide a series of haptic alerts in quick succession, emphasizing the need for caution and readiness, according to one embodiment.

By incorporating these sophisticated detection and alert systems, the tactical gear 104 may empower law enforcement officers with enhanced situational awareness, allowing them to preemptively identify potential threats and respond with appropriate caution and strategy, according to one embodiment. This technology may underscore a significant advancement in personal protective equipment, combining safety with intelligent threat detection to address the complex challenges faced by officers in the field, according to one embodiment.

The tactical gear 104, equipped with an array of advanced sensors (e.g, array 350 of sensors in FIG. 3, haptic and visual sensors, etc.) and powered by sophisticated AI algorithms, may be designed to enhance the situational awareness of law enforcement officers by detecting subtle cues and behaviors indicative of concealed weapons or contraband. This tactical gear 104 may address specific scenarios and behaviors as follows:

### Watch Their Hands:

Running Biomechanics Impacted: Advanced motion sensors (e.g., left side facing visual sensor 302, right side facing visual sensor 304, back facing visual sensor 306, front facing visual sensor 306, skyward facing visual sensor 100, etc.) and AI analysis may detect anomalies in an individual's running biomechanics, such as one arm moving less than the other or a hand consistently placed near a concealed area, suggesting the presence of a concealed weapon, according to one embodiment. Haptic feedback (e.g., haptic alert 118) may alert the wearer 114 of these observations, enabling them to approach the situation with heightened caution, according to one embodiment.

### Traffic Stop:

Repositioning Contraband with Legs: Visual sensors (e.g., left side facing visual sensor 302, right side facing visual sensor 304, back facing visual sensor 306, front facing visual sensor 306, skyward facing visual sensor 100, etc.) integrated into the helmet 102 may analyze the body language and movements of individuals during a traffic stop, according to one embodiment. The AI may identify specific behaviors, such as individuals looking down at their legs while repositioning objects with their feet, and provides a haptic alert 118 to signal the attempt to conceal contraband, according to one embodiment.

Direct Gaze and Continuous Reaching: The system's AI may process visual data to recognize when an attacker 436 consistently looks at or reaches toward a specific location on their body or within the vehicle, suggesting the hiding spot of a concealed item, according to one embodiment. This repeated behavior may trigger a specific pattern of haptic feedback, alerting the officer to potential concealment spots, according to one embodiment.

Clothing Adjustments and Leg Extension: Similar to visual cues, adjustments in clothing or unusual positioning, like a backseat passenger extending their legs in an unnatural manner, may be flagged by the AI, according to one embodiment. These actions, analyzed in real-time, may activate a corresponding haptic alert 118, indicating the possible concealment of objects, according to one embodiment.

Observation of Suspicious Items: The tactical gear's AI (e.g., AI model 110) may be trained to recognize the visual signatures of contraband packaging, such as graphic bags, small rubber bags, or unusual amounts of money, either through direct observation or relayed UAV footage, according to one embodiment. Upon detection, the officer may receive a haptic alert 118, guiding their search or questioning, according to one embodiment.

Pre-Stop Vehicle Movement: Sudden or excessive movement within a vehicle following the activation of police lights but before the vehicle stops may indicate attempts to hide contraband or weapons, according to one embodiment. The tactical gear 104, using inputs from motion sensors (e.g., left side facing visual sensor 302, right side facing visual sensor 304, back facing visual sensor 306, front facing visual sensor 306, skyward facing visual sensor 100, etc.) or UAV surveillance, may alert the officer to these last-minute adjustments, suggesting a thorough search upon stopping the vehicle, according to one embodiment.

Through these advanced detection methods and haptic feedback mechanisms, tactical gear 104 may significantly enhance an officer's ability to detect concealed weapons and contraband, promoting safety and efficacy during operations, according to one embodiment. This technology may enable officers (e.g., wearer 114) to interpret potential threats and contraband concealment behaviors more accurately, ensuring a well-informed approach to each encounter, according to one embodiment.

The integration of advanced technology into tactical gear 104 may offer a multifaceted approach to alerting wearers 114 about potential threats (e.g., ambient threat 408, imminent drone attack 422) or important situational changes, according to one embodiment. Beyond haptic feedback, which provides tactile alerts through vibrations, wearers 114 may receive notifications through audio, visual cues, and even coded language or keywords on display 106 and/or through the responsive device 108, according to one embodiment. These diverse notification methods may enhance situational awareness and allow for discreet communication that can maintain operational secrecy and safety, according to one embodiment.

### Audio Alerts:

Earpiece Communication: Wearers may receive spoken alerts through an earpiece connected to the tactical gear 104 and/or helmet 102 system, according to one embodiment. This method may allow for immediate communication of detailed information directly into the wearer's ear, minimizing the risk of suspects or bystanders overhearing sensitive data, according to one embodiment.

Coded Sounds: Specific tones or sequences of beeps may be used to represent different alerts, such as the urgency of a situation or the type of threat detected, according to one embodiment. These sounds may be designed to be recognizable to the wearer 114 but not to untrained ears, according to one embodiment.

### Visual Alerts:

Heads-Up Display (HUD): Some tactical gear 104 may include HUDs in eyewear or visors, providing visual notifications directly in the wearer's line of sight, according to one embodiment. Information may be displayed as icons, text, or even augmented reality overlays that do not obstruct the wearer's view but add valuable contextual information, according to one embodiment.

LED Indicators: Small LED lights on the tactical gear 104 and/or helmet 102 may flash or change color to signal different alerts, according to one embodiment. These indicators may be positioned to be easily seen by the wearer 114 without revealing the alert to others, according to one embodiment.

### Coded Language or Keywords:

Predefined Keywords: The AI system may use a speaker to utter predefined keywords that sound innocuous to bystanders but carry specific meanings for the wearer 114, according to one embodiment. For instance, saying “Omaha” may indicate the presence of a gun, while another name might signify different types of threats or situational updates, according to one embodiment.

Subtle Verbal Cues: The system may employ less explicit verbal cues that blend into normal conversation but are understood by the wearer 114 to convey messages or alerts. These may be phrases or references that, while seeming ordinary, may have been predetermined to carry specific meanings, according to one embodiment.

### Combined Notifications:

For enhanced effectiveness, these notification methods may be combined to ensure the wearer 114 receives and recognizes important alerts under various conditions, according to one embodiment. For example:

Dual Alerts: A visual alert for a specific threat might be accompanied by a tactile vibration to ensure the wearer 114 notices the alert even if they're momentarily not looking at the HUD, according to one embodiment.

Sequential Alerts: In situations where discretion is paramount, a coded keyword may be used first, followed by detailed information transmitted through an earpiece once it's safe to do so, according to one embodiment.

Priority Alerts: High-priority threats may trigger all forms of notification simultaneously to ensure immediate attention, whereas lower-priority alerts may only activate a single notification method to avoid overwhelming the wearer 114, according to one embodiment.

This sophisticated approach to notifications within tactical gear 104 may not only enhance the safety and effectiveness of law enforcement personnel and military operators but also provides flexibility in how information is disseminated and received during critical operations, according to one embodiment. By leveraging a combination of haptic, audio, visual, and coded language alerts, wearers 114 may remain acutely aware of their surroundings and any potential threats, all while maintaining operational discretion and minimizing the risk of miscommunication, according to one embodiment.

Upon the detection of such threats by the visual sensors of FIG. 3, the corresponding responsive device 108 embedded within the wearer's body activates, providing tactile, auditory or visual feedback in the form of vibrations, according to one embodiment. While FIG. 1 illustrates the placement of responsive device 108 primarily in the torso area, alternative configurations may be feasible, allowing for adaptable sensor distribution across the wearer's body, according to one embodiment.

The low profile, concavely curved camera housing 116 may utilize the artificial intelligence model 110 to differentiate benign objects from enemy versions of the loitering munition 206. For example, they may classify the loitering munition 206 as a friendly drone 204 and/or a hostile drone 202 (e.g., a classification operation 210 is illustrated in FIG. 2), according to one embodiment.

The camera housing 116 may be designed with an unobtrusive, inconspicuous profile having a concave curvature to fit seamlessly onto the helmet 102 without adding significant bulk and/or disrupting aerodynamics. The curvature of the camera housing 116 may be optimized to maximize the field of view, covering a wide visual spectrum to detect aerial objects effectively from various angles. The concave design of the camera housing 116 may optimize the field of view, allowing the sensor to capture a wide area of the sky above the wearer 114. The camera housing 116 may be constructed from materials that provide durability and protection for the embedded components against environmental elements and impact, according to one embodiment.

The top surface 112 may be the uppermost portion in the exterior of the helmet 102 on which the camera housing 116 may be installed. The installation of the low profile, concavely curved camera housing 116 on the top surface 112 of the helmet 102 enables an unobtrusive capture of the surrounding views by maximizing the field of view of the wearer 114 covering a wide visual spectrum to detect aerial objects effectively from various angles, according to one embodiment.

The artificial intelligence model 110 may be a compact, powerful AI processing unit embedded within the camera housing 116 of the helmet and/or linked wirelessly to a wearable computing device. This unit may be responsible for running advanced object detection and classification algorithms in real-time, utilizing deep learning and computer vision techniques. The artificial intelligence model 110 may continuously scan the environment, utilizing the skyward facing visual sensor 100 input to detect objects in the vicinity. This unit may run sophisticated algorithms for real-time data processing, object recognition, and decision-making based on the input from the visual skyward facing visual sensor 100. It may differentiate between benign objects (e.g., birds, commercial drones) and potential threats like loitering munitions 206 using shape, size, movement patterns, and thermal signatures. Once a potential threat is detected, the system may classify it as either a friendly drone 204 (i.e., allied forces or own assets) and/or a hostile drone 202 based on predefined characteristics such as flight patterns, markings, and known signatures. This classification may be crucial for immediate tactical decisions and ensures that friendly drones 204 are not mistakenly identified as threats and thereby causing a haptic response through the responsive device 108. The wearer 114 may receive real-time alerts (e.g., haptic alert 118) through the visual display 106 of the responsive device 108 or auditory signals if a hostile drone 202 is detected. The friendly drones 204 may be marked on a heads-up display with indicators to prevent confusion and enhance cooperative engagement. While the system primarily operates autonomously to detect and classify objects, the wearer 114 may retain manual control to override and/or adjust the AI's assessments or to focus on specific areas or objects through the display 106. All detections and classifications may be logged for post-mission analysis and continuous learning of the AI model 110. Data collected can be used to further train the AI algorithms, improving accuracy and adaptability over time, according to one embodiment.

The described system may integrate advanced artificial intelligence (AI) capabilities into a low-profile, concavely curved camera housing 116 mounted on the helmet 102. This innovative design focuses on enhancing situational awareness and defense mechanisms for military or security personnel by identifying and classifying aerial objects, specifically differentiating between benign objects (e.g., a bird 212, friendly drones 204, and hostile loitering munitions 206). The system may include capabilities for secure wireless communication to interface with other networked systems, allowing for data exchange and coordination with command centers 410 or other field units. The secure wireless communication of the system may enable the system to receive updates that might influence AI decision processes, such as new threat signatures or updates on friendly assets, according to one embodiment.

An integrated communication system of the responsive device 108 may enable the helmet 102 to connect to other networked devices and command centers 410, allowing for real-time data sharing and coordination. The integrated communication system of the responsive device 108 may provide updates to the wearer 114 and command units about identified threats or objects, according to one embodiment.

The responsive device 108 may notify the wearer 114 only when the loitering munition 206 is a hostile drone 202. The artificial intelligence model 110 may utilize anomaly detection to ignore ambient-sky video or images through a neural network that evaluates what is the expected appearance of the sky 200 under normal conditions as opposed to an anomalous condition when the loitering munition 206 is present in the sky 200, according to one embodiment.

The low profile, concavely curved camera housing 116 may attach on an upper surface of a helmet 102. An attachment means may be by way of a hook and loop method that permits the wearer 114 to reposition the low profile, concavely curved camera housing 116 on other parts of the helmet 102 and/or on a tactical vest worn by the wearer 114. The responsive device 108 may be a haptic sensor on any one of the helmet 102 and/or the tactical vest of the wearer 114, according to one embodiment.

An array 350 of visual sensors may be found on different sides of the low profile, concavely curved camera housing 116 to provide 360 degree situational awareness to the wearer 114 when an ambient threat 408 is detected using the artificial intelligence model 110. The responsive device 108 may provide haptic feedback to indicate a source, an azimuth, an elevation, and/or a proximity of an imminent drone attack 422, according to one embodiment.

A multistatic radar 424 on the tactical vest (e.g., tactical gear 104) of the wearer 114 may detect the loitering munition 206. A command center 410 may direct a series of counter measures to neutralize the hostile drone 202 in the imminent drone attack 422. The artificial intelligence model 110 may differentiate the hostile drone 202 from another object, such as a bird and/or a plane based on size, speed, a flight pattern, a visual characteristic, a heat characteristic, an electro-magnetic characteristic and/or an acoustic characteristic, according to one embodiment.

The artificial intelligence model 110 may identify a drone type, a model, and/or a potentially of its payload of the hostile drone 202 in the imminent drone attack by comparing sensor data against databases of known drone signatures to assess a level of threat, classify the drone type, the model, and/or the potentially of its payload of the hostile drone 202 and/or to decide on an appropriate response, according to one embodiment.

A counter-drone response system (e.g., shown in conceptual view of counter unmanned aircraft system 450 of FIG. 4) of the command center 410 may control an electronic warfare tool, such as a RF jammer 420 and/or a spoofer 418 to disrupt a communication system 412 and/or a navigation system 414 of the hostile drone 202 forcing it to land and/or return to its point of origin, according to one embodiment.

The low profile, concavely curved camera housing 116 may employ AI systems to continuously learn from encounters during imminent attacks, improving detection, identification, and/or interception capabilities of the loitering munition 206 over time. The display 106 may show analytics, such as reasons why the responsive device 108 vibrated, according to one embodiment.

In another embodiment, a counter-UAS (Unmanned Aircraft System) includes a skyward facing visual sensor 100 on a top surface 112 of a low profile, concavely curved camera housing 116, an artificial intelligence model 110 communicatively coupled with the skyward facing visual sensor 100, and a personal protective equipment. The skyward facing visual sensor 100 captures an ambient sky 400 above a wearer 114 of a tactical gear 104. The artificial intelligence model 110 detects a loitering munition 206 and/or a bird. The personal protective equipment having a responsive device 108 integrated in the tactical gear 104 and/or a helmet 102 haptically notifies the wearer 114 when the artificial intelligence model 110 detects a hostile drone 202 approaching a location having a blast radius 402 of the wearer 114 of the personal protective equipment.

The counter-UAS (Unmanned Aircraft System) may further include a sensor system (e.g., skyward facing visual sensor 100) communicatively coupled with the personal protective equipment. The sensor system may employ a sensor to include any of a radar, a radio frequency (RF) scanner, an acoustic sensor, and/or an optical camera to detect a presence of the hostile drone 202 approaching the location having the blast radius 402 of the wearer 114 of the personal protective equipment, according to one embodiment.

The counter-UAS (Unmanned Aircraft System) may further include a counter-drone response system of the personal protective equipment and/or a command center 410 to control an electronic warfare tool, such as a RF jammer 420 and/or a spoofer 418, to disrupt a communication system and/or a navigation system of the hostile drone 202 in the imminent attack, forcing it to land and/or return to its point of origin. The counter-UAS (Unmanned Aircraft System) may further include an anti-swarm module (e.g., see drone swarm 406 in FIG. 4) of the personal protective equipment and/or the command center 410 to track and neutralize multiple hostile drones 202 simultaneously. The sensor system may deploy a cope cage on a vehicle, an infrastructure, and/or the wearer 114 of the tactical gear 104, according to one embodiment.

In yet another embodiment, a personal protective equipment includes a responsive device 108 of a tactical gear 104 to haptically notify a wearer 114 of the tactical gear 104 when a skyward facing visual sensor 100 sees a hostile drone 202 within a blast radius 402 of the wearer 114. In addition, the personal protective equipment includes an artificial intelligence model 110 to utilize sky canceling machine learning (e.g., see canceled sky 208) to ignore a sky through a neural network that evaluates what an appearance is of an expected sky in a normal condition as opposed to an anomalous condition when the hostile drone 202 is present in the sky 200 surrounding the wearer 114 and within view of the skyward facing visual sensor 100, according to one embodiment.

FIG. 2 is a conceptual view 250 of a sky cancelation operation (circle ‘2’) and classification operation (circle ‘3’) based on visual observation (circle ‘1’) of the skyward facing visual sensor 100, according to one embodiment. In FIG. 2, the visual operation (circle ‘1’) shows a normal sky having loitering munitions 206 which includes a hostile drone 202 and a friendly drone 204. A bird 212 is also visible in the visual observation illustrated as circle ‘1’. In circle ‘2’, a sky cancelation operation is demonstrated in which the sky 200 is canceled by the artificial intelligence model 110. Then, in the classification operation in circle ‘3’, the hostile drone 202 is classified to have a threat level of 80% with a proximity distance of 440 ft as illustrated in label 210 in circle ‘3’.

The visual observation (circle ‘1’) of the skyward facing visual sensor 100 may include the sensor gathering real-time visual data from the sky, identifying and recording all observable elements within its field of view. The skyward facing visual sensor 100 integrated into the helmet 102 forms the foundational step in a sophisticated surveillance and threat assessment system. This sensor, enhanced with artificial intelligence (AI), plays a crucial role in monitoring and analyzing the aerial environment directly from the user's helmet 102. The skyward facing visual sensor 100 mounted on the helmet 102 with a skyward orientation may ensure an unobstructed view of the aerial surroundings. The sensor's placement is strategic to maximize coverage and field of view, capturing a comprehensive visual sweep of the sky above the wearer 114. High-resolution cameras within the skyward facing visual sensor 100 may capture real-time imagery and video of the sky. These cameras may be equipped with capabilities for both optical and infrared imaging, enabling detection across a range of conditions, including varying light levels and weather conditions for optimal performance, according to one embodiment.

As the visual data is captured, it is immediately processed by the AI algorithms embedded within the helmet's computing system (e.g., AI model 110). The AI begins by detecting all objects visible in the sky, from birds 206 and commercial aircraft to drones (e.g., friendly drone 204) and other aerial vehicles, according to one embodiment.

The AI may utilize advanced machine learning AI model 110 that have been trained on diverse datasets to recognize different types of aerial objects (e.g., bird 212, hostile drone 202, friendly drone 204, drone swarm 406, loitering munition 206, commercial aircraft, etc., These algorithms may analyze the visual data to identify characteristics such as size, shape, flight pattern, and speed. Once objects are detected, the AI model 110 may categorize them based on their identified characteristics. Benign objects like birds 212 or commercial aircraft may be quickly distinguished from potential threats such as loitering munitions 206. For each detected object categorized as potential munition, further analysis may be conducted to determine its nature-whether it is friendly or hostile. This determination may be based on additional data inputs like known signatures, markings, and/or encrypted signals that could indicate the object's alignment. The AI model 110 may assess loitering munitions 206 to classify them as either friendly (e.g., allied forces or owned assets) or hostile (enemy or unauthorized drones). This classification is crucial for subsequent response strategies and is achieved through cross-referencing with databases, signal analysis, and pattern recognition, according to one embodiment.

Once an object is classified, the system may immediately inform the wearer 114 via the helmet's and/or tactical gear's display 106, auditory and/or haptic alerts 118. Friendly drones 204 may be marked or tracked without alert, whereas hostile drones 202 trigger a threat alert, allowing the wearer 114 to take appropriate actions, according to one embodiment.

Visual observation (in circle ‘1’) through the skyward facing visual sensor 100 on the helmet 102, enhanced by AI, may provide a critical technological advantage in modern defense and security operations. By enabling the real-time detection and classification of aerial objects, this system may significantly boost the user's situational awareness and threat response capabilities, aligning seamlessly with broader military and security strategies, according to one embodiment.

The system may first collect the real-time visual data from the environment using the skyward facing visual sensor 100 or other sensory devices that have a skyward view. This data may include images or videos capturing everything within the device's field of vision. Thereafter, using image recognition algorithms, the artificial intelligence model 110 may identify all visible objects in the sky, such as drones, birds, aircraft, and other entities. This step may involve analyzing shapes, sizes, movement patterns, and possibly heat signatures to differentiate various objects. Each detected object may then be assessed to determine its potential threat level based on predefined criteria, which may include object type, behavior, trajectory, and known characteristics of friendly versus hostile entities, according to one embodiment.

Based on the threat assessment analysis of the artificial intelligence model 110, the non-threatening objects, such as identified friendly drones 204 or benign entities like birds 206, are then “canceled” from the operational focus. This means the AI algorithm may effectively ignore these objects in subsequent processing steps, reducing the processing load and focusing resources on analyzing potential threats. The cancellation can be visualized on a display 106 as these objects (e.g., canceled friendly drone 204) are faded out, shaded differently, or removed from the live visual feed shown to the user. The system may continuously monitor the environment for changes, adjusting the cancellation filters as new data becomes available or as objects move in and out of the sensor's range. This dynamic adjustment may help in maintaining optimal focus on relevant threats, according to one embodiment.

The AI system may use machine learning artificial intelligence model 110 that has been trained on vast datasets to recognize and categorize different types of aerial objects accurately. In addition, the AI system may use pattern recognition that is essential for differentiating objects based on visual features. The AI system may further employ neural networks to enhance the accuracy of real-time object detection and classification, according to one embodiment.

The sky cancellation operation (in circle ‘2’) represents a critical application of AI in enhancing visual data processing and decision-making capabilities. By effectively managing sensory overload and focusing on potential threats, these operations may significantly enhance both safety and efficiency in monitoring and response tasks, according to one embodiment.

The sky cancellation operation (in circle ‘2’) using Artificial Intelligence (AI) may refer to a sophisticated process where AI algorithms of the artificial intelligence (AI) model 110 are employed to selectively filter and prioritize visual data captured by sensors, such as those integrated into the helmet 102 and/or other surveillance systems in the network 405. This operation may be particularly useful in environments cluttered with various airborne objects where identifying and focusing on relevant threats is crucial. The primary purpose of the sky cancellation operation (in circle ‘2’) is to enhance situational awareness by reducing visual clutter. This may allow the system to focus on identifying and assessing potential threats more effectively, by ignoring identified non-threatening objects, according to one embodiment.

The classification operation in (in circle ‘3’) as illustrated may involve the use of a sophisticated artificial intelligence (AI) model 110 integrated with the skyward facing visual sensor 100 on a helmet 102. This stage is crucial in processing and interpreting the data captured during the initial observation phase (in circle ‘1’) and the subsequent filtering phase (sky cancellation operation in circle ‘2’), according to one embodiment.

The classification operation stage (shown in circle ‘3’) receives processed data from the previous steps where non-threatening objects such as birds 212 or benign aircraft have been identified and excluded and/or canceled). The input primarily consists of potential threats, which at this stage may include unidentified drones and loitering munitions 206, according to one embodiment.

The AI model 110 employed in this operation may be trained on extensive datasets to recognize and differentiate between various types of aerial objects, particularly focusing on characteristics that distinguish friendly drones 204 from hostile ones (e.g., hostile drones 202). The AI model 110 may analyze specific features of each detected object, such as size, shape, movement patterns, thermal signatures, and any electronic or radio frequency (RF) emissions that can be captured. This analysis may help in determining the nature of the object. Each object's features may be compared against a database of known profiles of friendly and hostile drones 202. This database may include parameters like standard drone models used by allied forces, typical configurations of enemy drones, flight behaviors, and/or other unique identifiers, according to one embodiment.

The AI model 110 may assess the threat level based on the comparison results. For example, drones exhibiting flight patterns or electronic signatures that match known hostile profiles may be classified as threats. Each object is classified as either a friendly drone 204, hostile drone 202, or remains unidentified if insufficient data is available. Friendly drones 204 are those that match with allied or own-force profiles, while hostile drones 202 are those that match adversary profiles and/or exhibit threatening behavior, according to one embodiment.

For hostile drones 202, the AI model 110 may further calculate the threat level based on proximity, potential armament, and likelihood of engagement. This calculation helps prioritize the response needed. The classification results, including the type of drone and its threat level, may be relayed in real-time to the wearer 114 through the helmet's heads-up display, tactical gear display 106, other auditory and/or haptic feedback systems via haptic alert 118. This information is critical for immediate decision-making and response actions, according to one embodiment.

The classification operation (in circle ‘3’) is vital for maintaining security and operational integrity in military and law enforcement scenarios. It may ensure that only genuine threats are addressed, allowing personnel to focus resources effectively and avoid unnecessary engagements. Moreover, accurate classification supports strategic decision-making, contributing to broader mission success. The classification operation (of circle ‘3’) in the described AI-enhanced helmet 102 system exemplifies advanced military technology designed to optimize situational awareness and threat response. By leveraging deep learning and data analytics, this system may ensure that operators are equipped with the necessary information to make quick, informed decisions in dynamic environments, according to one embodiment.

FIG. 3 is a perspective view of an alternative embodiment illustrating an array 350 of visual sensors on the camera housing 116 to detect an ambient threat, according to one embodiment. FIG. 3 illustrates an array 350 in which a left side view 310, a right side view 315, a back view 320, a front view 325, and a top view 330 is each illustrated, each having visual sensors. The purpose of these visual sensors is to detect ambient threats (e.g., such as the ambient threat 408 in FIG. 4) using the artificial intelligence model 110, according to one embodiment.

FIG. 3 illustrates an exemplary embodiment of a sophisticated camera housing 116 installed on the top surface 112 of the helmet 102 equipped with an array 350 of visual sensors, each strategically positioned to maximize surveillance capabilities and threat detection accuracy using artificial intelligence (AI) model 110. The left side view 310 illustrates the left side facing visual sensor 302 integrated on the left side of the helmet 102. It enhances the wearer's ability to perceive and respond to threats approaching from the left. The right side view 315 illustrates the right side facing visual sensor 304 integrated on the right side of the camera housing 116 on the helmet 102. The right side facing visual sensor 304 is positioned on the right side and monitors movements and potential threats from that direction. The back view 320 illustrates the back facing visual sensor 306 integrated on the rear of the helmet 102. This back-facing visual sensor 306 may be mounted on the back of the helmet and is responsible for monitoring any threats that might approach from behind, providing a full 360-degree surveillance capability for the wearer 114. The front view 325 illustrates the front facing visual sensor 308 integrated on the anterior portion of the helmet 102. Located at the front of the helmet 102, this sensor focuses on capturing visual data directly ahead of the wearer 114, enabling the detection of threats that are directly in the path or approaching the wearer 114. Positioned on the top of the helmet 102, the skyward facing visual sensor 100 may be oriented to monitor aerial threats directly above the wearer 114. The skyward facing visual sensor 100 may be particularly crucial for detecting flying objects such as drones or other aerial hazards, according to one embodiment.

The arrangement of these sensors may ensure that the wearer 114 has a complete and uninterrupted view of the surroundings. This setup is designed to eliminate blind spots and enhance situational awareness. Each sensor may feed its captured visual data into an AI model 110 that processes and analyzes the information in real-time. The AI model 110 may use machine learning algorithms to detect, analyze, and classify objects within the sensor's field of view. It can distinguish between benign elements (e.g., birds 212 or clouds) and potential threats (e.g., drones carrying weapons, loitering munition 206, etc.). The AI may assess all detected objects based on predefined threat parameters. It may classify them as either non-threats or threats, based on characteristics such as size, behavior, speed, and trajectory. For identified threats, the AI may further categorize the level of threat and predict potential actions, such as the trajectory of an approaching drone, according to one embodiment.

Once a threat is detected and classified, the AI may trigger an alert system integrated into the helmet 102. This system can provide visual signals through a heads-up display (HUD), auditory warnings via built-in earpieces, or tactile feedback (e.g., haptic alert 118) through vibrations. Alerts may include detailed information about the nature and urgency of the threat, allowing the wearer 114 to take immediate and appropriate action, according to one embodiment.

This helmet 102 may be ideally suited for military personnel or security forces operating in environments where aerial threats are prevalent. It may allow for preemptive responses and enhance the safety and effectiveness of operations. Police or special forces can use this helmet 102 during operations in urban settings where threats can emerge rapidly from multiple directions, according to one embodiment.

The helmet 102 equipped with a comprehensive array 350 of visual sensors (e.g., left side facing visual sensor 302, right side facing visual sensor 304, back facing visual sensor 306, front facing visual sensor 306, skyward facing visual sensor 100, etc.) represents a significant advancement in personal security technology. By integrating AI to analyze data from multiple perspectives, the system ensures that wearers 114 have the best possible situational awareness and are prepared to respond to threats from any direction, according to one embodiment.

FIG. 4 is a conceptual view 450 of a blast radius 402 of the wearer 114 that alerts the wearer 114 when the skyward facing visual sensor 100 detects the hostile drone 302 and/or an ambient threat 408, according to one embodiment. In FIG. 4, an ambient sky 400, a blast radius 402, a zenith 404, a drone swarm 406 (having hostile drones 302) and an ambient threat 408 is illustrated.

FIG. 4 illustrates a sophisticated defense system integrated into tactical gear 104, specifically designed for the wearer 114 equipped with the helmet 102 that includes the skyward facing visual sensor 100. The skyward facing visual sensor 100 may be crucial for scanning the sky and detecting aerial objects. It may be capable of a 360-degree field of view, capturing data on everything above the horizon line. The skyward facing visual sensor 100 may be protected and housed in the camera housing 116 mounted on the top surface 112 of the helmet 102, designed to withstand various environmental conditions while providing clear imagery. The skyward facing visual sensor 100 may be equipped with AI capabilities to identify and differentiate between various aerial objects, categorizing them as benign (e.g., birds 212) or potential threats such as hostile drones 202. The skyward facing visual sensor 100 may continually scan the sky above the wearer 114. It may be equipped with high-resolution cameras and other sensors like infrared or thermal detectors to capture a comprehensive view, according to one embodiment.

Using real-time imaging and data collection, the sensor (e.g., array 350 of visual sensors, skyward facing visual sensor 100) may identify all objects within its field of vision. This may include everything from birds 206 and commercial drones to potentially hostile entities, according to one embodiment.

When the AI model 110 detects a hostile drone 202 or an ambient threat 408, such as an incoming projectile or other aerial hazard, it may process and verify the threat level. The AI model 110 may process the data collected by the sensor to distinguish between benign and potentially threatening objects. It may analyze movement patterns, sizes, speeds, and other characteristic features of the detected objects. If an object matches the characteristics of known threats (e.g., hostile drones 202 or loitering munitions 206), the AI may classify it accordingly, according to one embodiment.

Upon detection and confirmation of a threat, the system may calculate the potential blast radius 402 of an impact from the hostile drone 202 or object. This blast radius 402 may represent the area around the wearer 114 that could be affected by the threat, whether through explosion, debris, or other impact effects. For identified threats, the AI may estimate critical parameters such as altitude, speed, trajectory, and payload based on available data. This estimation may be crucial for accurately determining the potential impact zone. Using predefined models and simulations, the AI calculates the blast radius 402. This calculation may consider the type of munition or drone, its payload, potential impact energy, and the environment around the impact zone. In more advanced systems, simulations may be run to predict multiple scenarios of how the event might unfold, refining the blast radius 402 estimation, according to one embodiment.

The zenith 404—the point in the sky directly above the observer (e.g., wearer 114) may be a crucial factor in calculating the blast radius 402 and effectively alerting the wearer 114 using an AI-driven skyward facing visual sensor 100. When considering aerial threats, such as drones or loitering munitions 206, understanding and calculating their position relative to the zenith 404 can significantly impact the accuracy and effectiveness of threat assessment and response mechanisms. The zenith 404 may provide a reference point for determining the exact position of an aerial object in the ambient sky 400. By measuring the angle between the zenith 404 and the detected object, the AI can accurately calculate the object's altitude and horizontal distance from the wearer 114. This geometric data is crucial for precise localization of the threat, according to one embodiment.

Knowing an object's position relative to the zenith 404 may allow the AI to project its trajectory more accurately. This is essential for predicting the potential impact point of a hostile drone 202 or loitering munition 206. Understanding the trajectory may help in determining where the drone will travel and where it might strike if uninterrupted, which directly influences the calculation of the blast radius 402. By calculating the distance and trajectory relative to the zenith 404, the AI can estimate the time it will take for a falling object to reach the ground. This estimation is vital for providing timely alerts to the wearer 114, allowing sufficient time to react and take cover if necessary. Calculating the distance to the zenith 404 and the corresponding angles helps refine the alert system's precision. The AI uses this data to provide more accurate alerts regarding the direction and immediacy of the threat, ensuring that the wearer 114 is informed with the best possible situational awareness, according to one embodiment.

The position of an object relative to the zenith 404 influences the calculation of the blast radius 402 in terms of both the potential area of impact and the severity of the explosion or collision. The AI considers these factors when computing how far debris or shrapnel might travel upon impact, which is critical for determining safe distances for the wearer 114. As the object moves in the sky, its position relative to the zenith 404 changes, and the AI dynamically adjusts its calculations of trajectory, impact timing, and blast radius 402. This ongoing adjustment ensures that the wearer 114 receives the most current and relevant data for decision-making. Information about an object's zenith angle and other spatial calculations can be shared with command centers 410 to coordinate broader security responses. Data collected about the object's movement in relation to the zenith 404 also feeds back into the AI model 110, helping to improve the algorithms and models used for future threat detection and response strategies. The zenith 404 plays a foundational role in the mechanics of using a skyward facing visual sensor 100 integrated with AI to detect and respond to aerial threats (e.g., drone swarm 406, hostile drone 202, etc.). Its use in calculating positional accuracy, trajectory, and blast radius 402 not only enhances the protective capabilities of tactical gear 104 but also significantly contributes to the overall effectiveness of security operations in dynamic and potentially hazardous environments, according to one embodiment.

Once the blast radius 402 is calculated, the system may immediately trigger alerts to the wearer 114 of the detected threat and the estimated blast radius 402. This alert could be visual, such as through a heads-up display (HUD) on the helmet's visor and/or via display 106 of the tactical gear 104, auditory through earpieces, and/or even tactile through vibration alerts (e.g., haptic alert 118) within the helmet 102 and/or tactical gear 104, according to one embodiment.

Data about the threat and its characteristics, including speed, trajectory, and type, and blast radius 402 information may be sent in real-time to the command center 410 and/or nearby units. This may allow for coordinated response strategies and further analysis. Based on the threat level and blast radius 402, the system may suggest immediate actions to the wearer 114, such as moving to a safe distance, taking cover, or preparing countermeasures. This advice may be based on the quickest and safest response to minimize risk, according to one embodiment.

As the threat continues to move or evolve, the system may keep tracking it, adjusting the blast radius 402 and alerts in real-time to accommodate any changes in the threat's behavior or trajectory. Information from the wearer's responses and outcomes are fed back into the AI model 110 to improve accuracy and response strategies for future encounters, according to one embodiment.

This system is particularly useful in military and security operations where awareness of aerial threats and quick response times are crucial. By providing real-time alerts and spatial awareness of potential dangers, the wearer 114 can make informed decisions rapidly, enhancing safety and tactical effectiveness. The integration of an AI-driven skyward facing visual sensor 100 into the helmet 102 and/or tactical gear 104 significantly enhances the wearer's ability to preemptively respond to threats. By conceptualizing the blast radius 402 upon detection of threats, the system aids in visualizing the immediate danger zone, enabling proactive defense maneuvers and minimizing the risk of harm to the wearer 114 and surrounding personnel, according to one embodiment.

This sequence of steps described herein may form a comprehensive response mechanism that not only identifies and classifies aerial threats but also proactively calculates potential dangers and informs the wearer 114 and command structures efficiently. The integration of AI may enhance the capability of tactical gear 104 and/or helmet 102 to handle complex scenarios with precision and speed, significantly improving safety and operational effectiveness in critical situations, according to one embodiment.

Furthermore, FIG. 4 depicts a multi-layered security system designed to protect against drone threats using an array 350 of sensors (e.g., left side facing visual sensor 302, right side facing visual sensor 304, back facing visual sensor 306, front facing visual sensor 306, skyward facing visual sensor 100, etc.) and countermeasures in the form of counter unmanned aircraft system integrated into both tactical gear 104 and the command center 410 by neutralizing drone threats, according to one embodiment.

The helmet 102 equipped with an array 350 of comprehensive sensor system (e.g., left side facing visual sensor 302, right side facing visual sensor 304, back facing visual sensor 306, front facing visual sensor 306, skyward facing visual sensor 100, etc.) may be capable of detecting a hostile drone 202. According to one embodiment, the sensor system of the helmet 102 and the tactical gear 104 may employ a suite of sensors in the form of counter unmanned aircraft system that may include:
A multistatic radar 424 of the counter unmanned aircraft system integrated into both tactical gear 104 and the command center 410 may detect objects by bouncing radio waves off them and interpreting the reflected signals. The multistatic radar 424 may detect drones based on their shape, speed, and trajectory, according to one embodiment. Ground-based radar systems 426 may detect drones (e.g., hostile drone 202) approaching a target by identifying objects moving through their coverage area. The ground-based radar systems 426 of the counter unmanned aircraft system may include radio frequency (RF) scanner 428, acoustic sensor 430, radar 432, and optical camera 434. Advanced radar systems may be particularly adept at spotting small, low-flying drones (e.g., drone swarm 406) by distinguishing them from other moving objects like birds or small aircraft. Short-range, high-resolution radar systems may be effective for this purpose, providing early warning of an approaching drone, according to one embodiment.

The Radio Frequency (RF) Scanner 428 of the counter unmanned aircraft system may identify drones from the drone swarm 406 by scanning for RF communications commonly used by drones to operate. The RF scanner 428 may pick up communication and/or control signals between drones and their operators, according to one embodiment. These systems may detect the RF signals between drones and their operators. Since drones may communicate with their controllers using radio signals, RF detection systems may identify these communications, indicating the presence of a hostile drone 202. These systems may be highly effective in detecting drones that are controlled remotely, potentially even before the hostile drone 202 is physically near the wearer 114, according to one embodiment.

The acoustic sensor 430 of the counter unmanned aircraft system may pick up sound signatures specific to hostile drone 202, such as the whirring of rotors and/or unique sounds of drone propellers, according to one embodiment. Utilizing arrays of microphones, acoustic sensors 430 can identify the unique sound signatures produced by drone propellers and motors. These systems may be particularly useful for detecting hostile drones 202 that are attempting to approach a wearer 114 (and/or infrastructure, a vehicle) quietly and at low altitudes, where visual detection may be difficult, according to one embodiment.

The sensor system may be designed to detect imminent drone attacks 422 near the sensor or a specific target leverage a combination of technologies to identify, track, and sometimes neutralize incoming unmanned aerial vehicles (UAVs). Each type of sensor may provide unique capabilities in identifying drone characteristics such as size, speed, altitude, and operational frequencies, according to one embodiment.

Optical cameras 434 may visually detect hostile drones 202 in the vicinity of the sensor system or target during daylight hours. Infrared cameras may detect the heat signatures produced by drones, making them effective for nighttime detection. These systems may be automated to alert operators to unusual movements or heat signatures that correspond with drone activity. However, their effectiveness may be diminished by poor weather conditions or obstructions in the line of sight, according to one embodiment.

Lidar (Light Detection and Ranging) systems may detect drones by emitting laser pulses and measuring the time it takes for the pulses to bounce back after hitting an object. This technology may generate detailed three-dimensional images of hostile drones 202 approaching a target (e.g., a blast radius 402). Lidar may be effective in various weather conditions and may detect hostile drones 202 with a high degree of accuracy, although it may be expensive and has a relatively limited range compared to radar, according to one embodiment.

Electro-Optical (EO) Systems may use cameras to detect objects based on visible light. When combined with infrared (IR) sensors of the sensor system for thermal imaging, EO/IR systems may effectively identify hostile drones 202 approaching a target by their shape during the day and by their heat signatures at night. These systems may also be equipped with tracking capabilities to follow a drone's movement once detected, according to one embodiment.

High-definition optical camera 434 may offer visual confirmation. These cameras may capture detailed imagery, supporting identification and classification of the threat. When coupled with machine learning algorithms, the sensor system may automatically recognize and categorize different types of aerial threats, according to one embodiment.

UAV-Mounted Sensors on UAV equipped with similar sensor technologies (radar, LIDAR, infrared, and cameras) may provide a bird's-eye view of the battlefield, extending the detection range far beyond the immediate vicinity of the vehicle. These UAVs may relay crucial information back to the vehicle in real-time, according to one embodiment.

Ground-Based Sensor Arrays (e.g., ground-based radar system 426) of the sensor system may be in strategic locations. These stationary sensors may form a network that offers wide-area surveillance, creating a perimeter of security. They may detect threats such as imminent drone attack 422 approaching from different directions and altitudes, feeding data back to the command centers 410 and the wearer 114, according to one embodiment.

Satellite Sensors may offer the broadest coverage, satellite sensors may monitor large swathes of territory from space. Equipped with advanced imaging, radar, and infrared technologies, satellites may detect missile launches or large drone formations (e.g., drone swarm 406) early, providing vital strategic intelligence, according to one embodiment.

Communication and Data Links may enable off-vehicle sensors to be effective, where robust communication and data link systems are essential. These systems may ensure secure, low-latency transmission of sensor data to the vehicle, enabling the AI to process and respond to threats in real-time, according to one embodiment.

To ensure comprehensive coverage and mitigate the limitations of each sensor type, a multi-sensor approach may be employed. By integrating data from radar 432, RF detectors (e.g., RF scanner 428, acoustic sensors 430, and optical/IR cameras 434, ground-based systems (e.g., ground-based radar system 426) can create a layered defense capable of detecting and assessing the threat of an imminent drone attack with high accuracy. This integrated approach enhances the ability to detect, track, and respond to drones before they can reach their intended targets, providing critical time for countermeasures to be enacted, according to one embodiment.

The optical camera 434 of the counter unmanned aircraft system may visually identify drones, potentially using image recognition software to differentiate between friendly and hostile units of the drone swarm 406, according to one embodiment.

The sensors of the sensor system may work in tandem to detect the presence of a hostile drone 202, indicated by the imminent drone attack 422. This multi-sensor approach may increase accuracy and reduce the chance of false positives, according to one embodiment.

Upon detecting a threat, the sensor system may calculate the potential blast radius 402 of an attack, informing response measures and evacuation protocols. The potential blast radius 402 may underscore the critical need for timely detection and response to mitigate the risk of damage from a drone attack, according to one embodiment.

When the sensor system detects a drone that poses a threat, it may send an alert through the network 405 to both the command center 410 and the tactical gear 104. A geo-location device of the system may identify a present location of the wearer 114 when the sensor system detects the imminent drone attack 422. The present location is communicated to the command center 410. The haptic response mechanism in the tactical gear 104 may be then activated, notifying the wearer 114 of the imminent threat. The command center 410 may direct a series of counter measures to neutralize the hostile drone 202 in the imminent drone attack 422, according to one embodiment.

C-UAS (Counter-Unmanned Aircraft Systems) of FIG. 4 may be a system that uses a variety of methods to detect, track, and neutralize hostile drones 202. They can include electronic warfare methods to jam the communication and control signals of drones (e.g., navigation system 414 and communication system 412 of the hostile drone 202), kinetic methods to physically intercept and destroy them (like nets or projectiles), and laser systems to damage or destroy drones, according to one embodiment.

The tactical gear 104 and the helmet 102 can be wirelessly connected to both the ground based radar system 426 and external sensor networks (e.g., sensor system). This connection allows it to receive real-time updates about aerial threats. In addition to haptic alerts 118, the tactical gear 104 can incorporate visual signals (LEDs) or auditory signals (earpiece connectivity) for comprehensive awareness. This may enhance situational awareness of the wearer 114 without relying solely on visual or auditory cues, which can be crucial in noisy, chaotic combat environments because it may enable the wearer 114 to react quickly to threats, especially when inside vehicles or buildings where visibility may be limited. In conflict zones, civilians equipped with the tactical gear 104 can receive early warnings about imminent drone attacks 422, giving them crucial seconds to seek cover or evacuate the area. This may be particularly useful in humanitarian operations, providing aid workers with an additional layer of safety while operating in high-risk areas. The system may require a centralized control unit within the command center 410 to process threat data and broadcast it to all connected vests in the vicinity. Regular updates and synchronization with the AI system may ensure that the tactical gear's 104 alert protocols are always aligned with the latest threat detection capabilities, according to one embodiment.

This tactical gear 104 concept may combine modern wearable technology with advanced threat detection systems (e.g., using threat detection model of the compute module), offering a proactive solution to enhance safety and situational awareness for both military personnel and civilians (e.g., wearer 114) in conflict zones, according to one embodiment. The tactical gear 104 designed for alerting wearers 114 of incoming drone threats through haptic, visual, and auditory signals may be crafted with the intent of providing both flexibility and comprehensive situational awareness. This detailed approach ensures that individuals can receive and understand alerts without being overwhelmed or distracted, which can be crucial in high-stress environments, according to one embodiment.

The tactical gear 104 may have a user interface, possibly a small, rugged, touch-screen panel or a mobile application, allowing the wearer 114 to personalize how they receive alerts. For instance, a wearer 114 might prefer strong vibrations for imminent threats but softer pulses for alerts about distant hostile drones 202, according to one embodiment.

Integrated actuators distributed throughout the tactical gear 104 may deliver vibrations or pulses directly to the wearer's body. These can vary in pattern and intensity, providing a nuanced and immediate sense of the threat's direction and urgency, according to one embodiment. For instance, escalating vibrations (e.g., haptic alert 118) can indicate an approaching ambient threat 408, while a single strong pulse can signal an immediate need to take cover, according to one embodiment.

LED strips or patches integrated into the tactical vest's 104 fabric can light up or change color based on the threat level, according to one embodiment. For nighttime operations, these lights can be visible only through night-vision goggles to prevent giving away the wearer's position, according to one embodiment. A color-coded system might use green to indicate all-clear, yellow for caution, and red for immediate danger, according to one embodiment. For wearers 114 equipped with tactical earpieces, the tactical gear 104 can send auditory alerts directly to the earpiece. This can include synthesized voice warnings with details about the threat (“Drone incoming, 200 meters, northeast”) or coded sounds designed to convey urgency and direction without the need for translation. The volume and nature of these sounds can be adjusted based on ambient noise levels and the wearer's hearing protection, according to one embodiment.

The integration of these haptic alert 118 systems aims to create a multimodal awareness environment, ensuring that the wearer 114 can quickly and accurately assess ambient threats 408 without needing to rely on a single sense, according to one embodiment. This approach may be particularly valuable in combat or disaster-response scenarios, where sensory overload is common, and the ability to quickly interpret and act on information can be life-saving, according to one embodiment. The customizable nature of the alert system may ensure that it can be adapted not only to individual wearer preferences and needs but also to the specific operational context, enhancing both personal safety and mission effectiveness, according to one embodiment. This level of customization and integration of alerts represents a significant advancement in wearable defense technology, offering a new standard for personal situational awareness in high-risk environments, according to one embodiment. Creating a system where each individual (e.g., wearer 114) may be paired with a personal surveillance drone (e.g., using drone system) for counter-drone operations involves a sophisticated network of wearable technology, drone control systems, and AI-driven command and control protocols, according to one embodiment.

AI-Driven command and control system (e.g., using a compute module of the tactical gear 104) may be a centralized software that processes data from all deployed personal drones, analyzes threats, and coordinates counter-drone responses, according to one embodiment. This system can identify enemy drones, assess their threat level, and recommend or automate countermeasures, according to one embodiment. Upon detection of an enemy hostile drone 202 or drone swarm 406, the counter unmanned aircraft system alerts the wearer 114 through their wearable control unit, according to one embodiment. The wearer 114 can then deploy their personal surveillance drone (e.g., UAV) with a single command using the drone control apparatus, according to one embodiment. The deployed drones autonomously navigate to the threat location identified as blast radius 402, using onboard sensors (e.g., thermal sensor) to gather intelligence, according to one embodiment. This data may be relayed back to the command and control system (e.g., database of the command center 410) for analysis, according to one embodiment.

Based on the threat analysis, the system may determine the best course of action. If a direct impact with the enemy's hostile drone 202 is deemed the most effective response, the system can direct the personal surveillance drone (e.g., UAV) to intercept and neutralize the threat, according to one embodiment. The wearer 114 may have the option to manually control their drone at any time, using the wearable drone control apparatus to direct the drone's movements, adjust surveillance parameters, or execute a counter-drone maneuver, according to one embodiment.

After the threat is neutralized, the drone (e.g., UAV) returns to the wearer 114, automatically docking with a charging station integrated into the wearable drone control apparatus or the user's patrol vehicle to prepare for the next deployment, according to one embodiment.

The counter unmanned aircraft system of the helmet 102 and the command center 410 may control an electronic warfare tool, such as a RF jammer 420 and a spoofer 418, to disrupt the communication system 412 and the navigation system 414 of the hostile drone 202 in the imminent attack. The RF jammer 420 may cut off the control of a hostile drone from its operator and the spoofer 418 may interfere with the drone's navigation system 414, forcing it to land or return to its point of origin. The command center 410, upon receiving the same information, may coordinate an appropriate defense strategy, which may include deploying countermeasures against the drones. The countermeasures may aim to neutralize the drone without engaging in kinetic or destructive action, minimizing the risk of collateral damage. FIG. 4 illustrates a comprehensive approach to drone defense, combining detection, communication, wearer notification, and electronic countermeasures to ensure a swift and effective response to aerial threats, according to one embodiment.

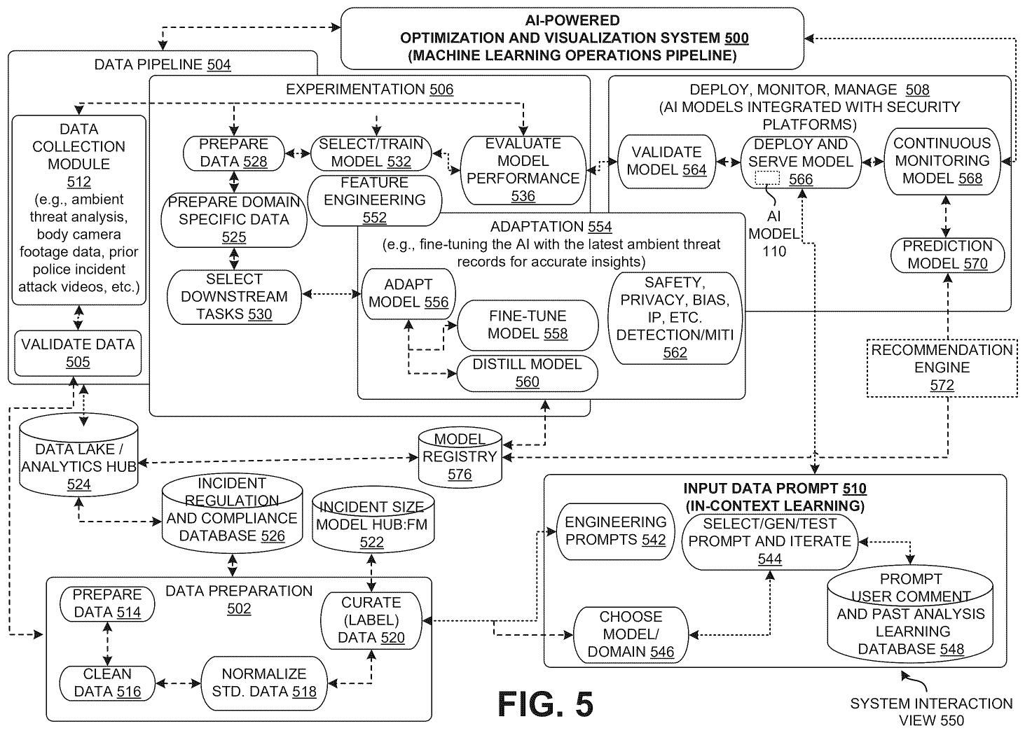

FIG. 5 is a system interaction view 550 that visually represents the intricate process of developing and implementing generative AI models 110 within the context of GovGPT™ AI-powered optimization and visualization system 500. The lifecycle of this system may ensure that it not only processes and categorizes tactical gear 104 ambient data efficiently but also provides insightful analytics and interactive visualizations to users. Below is a summary of each element:

Data Pipeline 504: This involves collecting (e.g., using data collection module 512 of the data pipeline 504) and validating a wide range of data (e.g., using validate data 505 of the data pipeline 504), including the skyward facing visual sensor 100 ambient data, captured conversations, and sentiment analysis. The ambient data may include the body camera footage data, the incident sensory data, ambient threat analysis, and the prior police incident attack videos, etc. The data then flows into a data lake or analytics hub 524 and feature store for subsequent tasks. In helmet's context, the Data Pipeline 504 may involve collecting and validating data pertinent to public opinions, pre-incident video data, public record with prior police incident videos of police being attacked by ambient threats, body camera footage, history of crowd dynamics and behavior, etc., according to one embodiment

The data preparation 502 may be the process of preparing raw data extracted from the data lake and/or analytics hub 524 based on the prompt received from a user so that it is suitable for further processing and analysis by the AI-powered optimization and visualization system 500 of the skyward facing visual sensor 100. The data preparation 502 may include collecting, cleaning, and labeling raw data into a form suitable for machine learning (ML) algorithms and then exploring and visualizing the data. The data preparation 502 phase may include prepare data 514, clean data 516, normalize standardized data 518, and curate data 520. The prepare data 514 may involve preprocessing the input data (e.g., received using the data collection module 512) by focusing on the data that is needed to design and generate a specific data that can be utilized to guide data preparation 502. The prepared data 514 may further include conducting geospatial analysis to assess the physical attributes of each incident, etc. In addition, the prepared data 514 may include converting text to numerical embeddings and/or resizing images for further processing, according to one embodiment.

The clean data 516 may include cleaning and filtering the data to remove errors, outliers, or irrelevant information from the collected data. The clean data 516 process may remove any irrelevant and/or noisy data that may hinder the AI-powered optimization and visualization system 500, according to one embodiment.

The normalize standardized data 518 may be the process of reorganizing data within a database (e.g., using the data lake and/or analytics hub 524) of the AI-powered optimization and visualization system 500 so that the AI model 110 may utilize it for generating and/or address further queries and analysis. The normalize standardized data 518 may be the process of developing clean data from the collected data (e.g., using the collect data module 512) received by the database (e.g., using the data lake and/or analytics hub 524) of the AI-powered optimization and visualization system 500. This may include eliminating redundant and unstructured data and making the data appear similar across all records and fields in the database (e.g., data lake and/or analytics hub 524). The normalize standardized data 518 may include formatting the collected data to make it compatible with the AI model 110 of the AI-powered optimization and visualization system 500, according to one embodiment.

The curate data 520 may be the process of creating, organizing and maintaining the data sets created by the normalize standardized data 518 process so they can be accessed and used by people looking for information. It may involve collecting, structuring, indexing and cataloging data for users of the AI-powered optimization and visualization system 500. The curate data 520 may clean and organize data through filtering, transformation, integration and labeling of data for supervised learning of the AI model 110. Each data in the AI-powered optimization and visualization system 500 may be labeled based on whether they are suitable for processing. The normalize standardized data 518 may be labeled based on the incident size model hub 522 and input data prompt 510 of the database (e.g., using incident regulation and compliance database 526), according to one embodiment.

The data lake and/or analytics hub 524 may be a repository to store and manage all the data related to the AI-powered optimization and visualization system 500. The data lake and/or analytics hub 524 may receive and integrate data from various sources in the network to enable data analysis and exploration for optimization and visualization, according to one embodiment.

Experimentation 506: This phase includes preparing data 528, engineering features 552, selecting and training models 532, adapting the model 556, and evaluating the model's performance 536. Experimentation 506 in GovGPT™ personal protective equipment's case may encompass the AI analyzing various ambient scenarios and sensors of the tactical gear 104 to suggest the most prevalent concerns and sentiments, according to one embodiment.

In the adaptation 554 phase, the machine learning models may adapt and improve their performance as they are exposed to more data by fine tuning (e.g., using the fine-tune model 558) the adapt model 556 for a specific threat incident and include additional domain specific knowledge. The adapt model 556 may modify the model architecture to better handle a specific task. The fine-tune model 558 may train the model on a curated dataset of high-quality data by optimizing the hyperparameters to improve model performance. The distill model 560 may simplify the model architecture to reduce computational cost by maintaining and improving model performance. The system may implement safety, privacy, bias and IP safeguards 562 to prevent bias and discrimination while predicting a threat incident. The system may ensure model outputs are fair and transparent while protecting the sensitive data as well.

Maturity Level 1: Prompt (e.g., using engineering prompts 542), In-Context Learning, and Chaining: At this stage, a model is selected from the model registry 576 using the choose model/domain 546 and prompted (e.g., input data prompt 510 in-context learning of the data pipeline 504) to perform a task, according to one embodiment. The responses are assessed and the model is re-prompted using the select/gen/test prompt and iterate 544 if necessary. In-context learning (ICL) may allow the model to learn from examples without changing its weights (e.g., using the prompt user comment and past analysis learning database 548 in-context learning of the data pipeline 504). In GovGPT™ tactical gear 104, Prompt and In-Context Learning can involve prompting the AI with specific ambient and sensor data and learning from past analyses to enhance its predictive capabilities, according to one embodiment.

Chain it: This involves a sequence of tasks starting from data extraction, running predictive models 570, and then using the results to prompt a generative AI model 110 to produce an output. In GovGPT™ tactical gear 104, Chain it can mean applying predictive analytics to ambient signal data to inform civic engagement and policy decisions, according to one embodiment.

Tune it: Refers to fine-tuning the model 558 to improve its responses. This includes parameter-efficient techniques and domain-specific tuning (e.g., using the prepare domain specific data 525 and select downstream tasks 530). In GovGPT™ tactical gear 104, tune it may involve fine-tuning the AI using the fine-tune model 558 with the latest ambient data captured from tactical gears deployed, according to one embodiment.

Deploy, Monitor, Manage 508: After a model is validated (e.g., using the validate model 564), it is deployed (e.g., using the deploy and serve model 566), and then its performance is continuously monitored using the continuous monitoring model 568, according to one embodiment. Deployment in GovGPT™ tactical gear's case may see the AI being integrated into municipal platforms, where it can be monitored and managed as users interact with it for tactical gear 104 ambient data analysis, according to one embodiment.

Maturity Level 3: RAG it & Ground it: Retrieval Augmented Generation (RAG) is used to provide context for the model by retrieving relevant information from a knowledge base, according to one embodiment. Grounding ensures the model's outputs are factually accurate. In GovGPT™ tactical gear 104, RAG and Grounding may be utilized to provide contextually relevant information from civic databases to ensure recommendations (e.g., generated using the recommendation engine 572 of the data pipeline 504) are grounded in factual, up-to-date ambient signal and policy data, according to one embodiment.

FLARE it: A proactive variation of RAG that anticipates future content and retrieves relevant information accordingly. In GovGPT tactical gear 104, FLARE it can predict future trends in opinion or emerging community concerns that can affect policy-making, according to one embodiment.

CoT it or ToT it. GOT it: These are frameworks for guiding the reasoning process of language models, either through a Chain of Thought, Tree of Thought, or Graph of Thought, allowing for non-linear and interconnected reasoning. In GovGPT™ tactical gear 104, CoT, ToT, GoT frameworks may guide the AI's reasoning process as it considers complex opinion patterns, ensuring it can explore multiple outcomes and provide well-reasoned, data-driven insights, according to one embodiment.

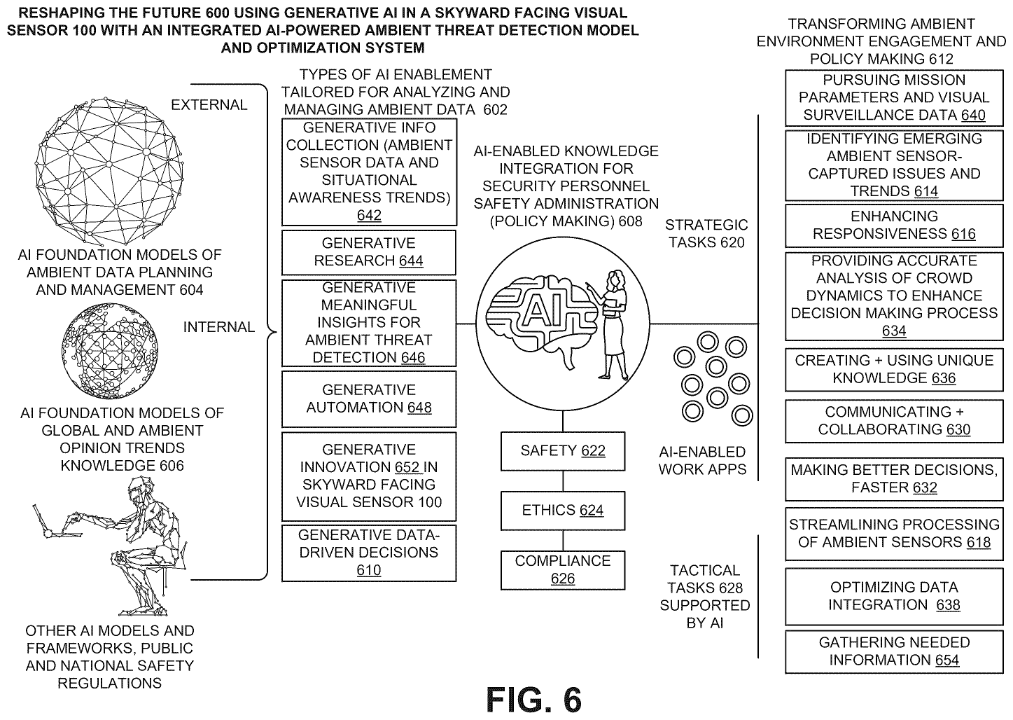

FIG. 6 illustrates the innovative application of “Generative AI in Skyward Facing Visual Sensor 100 Management using an Integrated AI-Powered Ambient Threat Detection Model,” as conceptualized in one embodiment of the GovGPT™ tactical gear 104 system. It highlights how artificial intelligence, particularly generative AI, may revolutionize the way ambient data are processed, analyzed, and utilized in governmental, military, law enforcement, fire and civic uses, according to one embodiment. The image is divided into three sections:

Types of AI Enablement Tailored for Analyzing and Managing Ambient Data 602: This section showcases generative AI foundation models specifically tailored for analyzing and managing ambient data 604. It emphasizes the system's capability to understand global and ambient opinion trends 606 and to extract meaningful insights from a vast array 350 of ambient sensors. This process may particularly involve generative info collection such as ambient sensor data and situational awareness trends 642, generative research 644 and meaningful insights for ambient threat detection 646, generative automation 648, generative innovation 652 in skyward facing visual sensor 100, and making generative data-driven decisions 610, according to one embodiment.

AI-Enabled Knowledge Integration for Public Safety Administration 608: This part emphasizes the AI's capabilities in transforming the way government officials and agencies engage with their constituents. It highlights how the AI aids in making data-driven decisions, ensuring law enforcement and security personnel safety 622, ethics 624, and compliance 626 within the realms of public safety administration and policy-making.

Transforming Ambient Environment Engagement and Policy-making 612: The final section is divided into strategic tasks 620 such as identifying emerging ambient sensor-captured concerns and trends 614 that can influence policy decisions, and tactical tasks 628 like streamlining the processing of ambient sensors 618, optimizing data integration 638, and enhancing the responsiveness 616 of military, law enforcement, and first responder bodies, according to one embodiment. The strategic tasks may further include pursuing mission parameters and visual surveillance data 640, providing accurate analysis of crowd dynamics to enhance decision making process 634, creating and using unique knowledge 636, communicating and collaborating 630 for making better decisions faster 632 by gathering needed information 654. The visualization serves as a powerful explanation of GovGPT™ tactical gear's role in pioneering the future of ambient skyward facing visual sensor 100 computing, according to one embodiment.

FIG. 6 demonstrates the transformative impact of AI on governance and security personnel safety management, particularly through the analysis of ambient signals, according to one embodiment. Strategically, the AI identifies emerging issues and trends 614 in ambient signals, informing policy-makers (e.g., communicating+collaborating 630) about the pressing concerns of their constituents. This insight can be crucial in addressing societal challenges and improving community relations. It also enhances the decision-making process (e.g., by making better decisions faster 632) by providing accurate analysis of crowd dynamics to enhance the decision making process 634, using unique knowledge 636, optimizing data integration 638, and pursuing mission parameters and visual surveillance data 640, according to one embodiment. This integration of AI in public administration represents a significant advancement in enhancing democratic engagement, making the public consultation process more accessible and impactful, according to one embodiment.

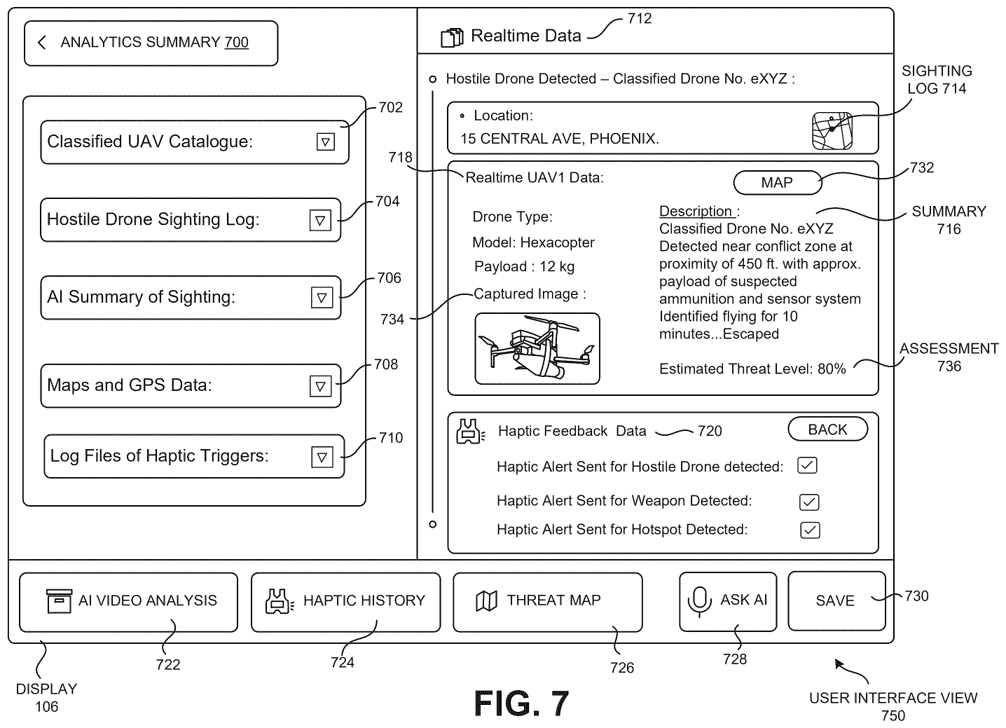

FIG. 7 is a user interface view 750 illustrating a display 702 of a computing device (e.g., a mobile device, a tablet of a wearer 114, a computer monitor at the command center 410) exhibiting a detailed summary 716 of a hostile drone 202 identified by the sensor system of the helmet 102 of FIG. 1, according to one embodiment. Upon detecting the hostile drone 102, the system's generative AI component steps in, generating detailed descriptions of the drone directly on the hardwired display 106 (e.g., a tablet computer, mobile computer, etc.), according to one embodiment. In one embodiment, these descriptions are generated without electronic signature through edge computing based inference, according to one embodiment. These descriptions (e.g., summary 716) may include the type, model, potential payload, and an assessment of the threat level. Simultaneously, the system automatically captures images of the drone and its location, according to one embodiment. The wearer 114 is alerted through a haptic feedback device (e.g., responsive device 108) embedded in the helmet 102 or tactical vest 104, which vibrates gently to notify them of the drone's presence and provide a summary 716 of the drone's details, according to one embodiment.

To enhance its functionality, this detection system is integrated with a mobile/web app on mobile device on the wearer 104 associated with the display 106 to which the camera housing 106 is coupled, according to one embodiment. The app is designed to automatically catalog all sightings, saving the captured images and generated descriptions of hostile drones, according to one embodiment. Users can customize the app to focus on specific types of drones or threat levels, filtering and highlighting sightings according to their preferences, according to one embodiment. The app also maintains a historical record of all drone sightings, providing detailed descriptions (e.g., summary and images of where each drone was seen, according to one embodiment. This display may be visible through a mobile device in a wearable Juggernaut Case® (e.g. phone flips downward from a center chest area) and ITAC (Intelligent Threat Assessment and Countermeasures) are typically systems used in military and security contexts for enhanced situational awareness, threat detection, and response coordination, according to one embodiment.

In addition to real-time detection and notification, the app offers real-time alerts and notifications, enabling users to respond promptly to any detected threats, according to one embodiment. This immediate access to crucial information enhances situational awareness and aids in efficient threat management, according to one embodiment.

The analytics summary 700 displayed on the user interface view 750 provides a holistic overview of critical data points and operational insights, facilitating informed decision-making and strategic planning, according to one embodiment.

### Detailed Components of the Analytics Summary 700:

Classified UAV catalog 702 tab may provide specifics on the UAVs and database of identified UAV types. The classified UAV catalog 702 may include a database of UAVs that are specifically identified as hostile drones 202 using classification operations described and shown in circle ‘3’ of FIG. 2. The classified UAV catalog 702 may be an integral component of a sophisticated surveillance and/or defense system, providing comprehensive details and specifications about various unmanned aerial vehicles (UAVs). The classified UAV catalog 702 may serve as a detailed database, enabling quick access to critical information about UAVs that have been identified, categorized, and analyzed in past operations and/or through intelligence gathering. Each UAV type listed in the classified UAV catalog 702 may have a dedicated profile that includes detailed specifications such as make, model, dimensions, weight, flight capabilities (e.g., maximum altitude, speed), and operational range. The profiles may also detail the UAV's typical uses, which could range from surveillance, delivery, and/or reconnaissance to more aggressive roles like armed attacks or espionage. The high-resolution captured images 734 and possibly 3D models of each UAV type listed in the classified UAV catalog 702 may help in visual identification. This section may include notes on distinctive features such as body shape, color patterns, and markings that can aid wearers 114 in quickly recognizing the UAV in the field, according to one embodiment.

The classified UAV catalog 702 may also provide infrared and thermal signatures, which are crucial for identification during night operations and/or through sensors that track heat emissions. The classified UAV catalog 702 may include details about possible payloads that UAVs can carry, including cameras, sensors, weaponry, and/or other specialized equipment. This information is crucial for assessing the threat level and potential mission intent of the UAV. The classified UAV catalog 702 may further include information on the types of communications equipment the UAV may use, including GPS, satellite communication links, and/or local RF communications. This may also cover any known frequencies and encryption methods used, aiding in electronic warfare operations like signal interception and/or jamming. The classified UAV catalog 702 may provide insights into the UAV's deployment history, including geographical areas and conflict zones where it has been previously used. This can provide context on the likely operators and their operational tactics, according to one embodiment.

The classified UAV catalog 702 may include advanced search functionalities that allow users (e.g., wearer 114, command center 410) to filter UAVs by type, manufacturer, size, known operators, and/or capabilities. This enables quick access to relevant information during time-sensitive operations. The classified UAV catalog 702 may be typically integrated with radar, optical, and other sensor systems (e.g., left side facing visual sensor 302, right side facing visual sensor 304, back facing visual sensor 306, front facing visual sensor 306, skyward facing visual sensor 100, etc.) used in drone detection. When a UAV is detected, the helmet 102 system can automatically reference the catalog to provide immediate information about the detected UAV type, enhancing response effectiveness. The UAV classified UAV catalog 702 may be regularly updated with new data as more UAV types are identified and as existing UAV models are modified or upgraded. This ensures that the information remains current and comprehensive. Access to the classified UAV catalog 702 may be usually restricted to authorized personnel only (e.g., wearer 114, command center 410), given the sensitive nature of the information. Security measures include encryption, user authentication protocols, and audit trails to monitor access and usage, according to one embodiment.

The database of the classified UAV catalog 702 may be used by armed forces to identify enemy UAVs quickly, assess their capabilities, and determine appropriate countermeasures. This system may help in identifying potential threats from UAVs in domestic airspace, particularly in securing critical infrastructure or during major public events. For organizations operating in sensitive areas, having access to such a classified UAV catalog 702 may help in risk assessment and in developing security protocols against potential UAV surveillance or attacks, according to one embodiment.

The classified UAV catalog 702 may be a critical resource in modern security and defense environments, where UAVs play an increasingly prominent role. By providing detailed, actionable information, this catalog enhances situational awareness and operational readiness against a range of aerial threats, according to one embodiment.

Hostile drone sighting log 704 may be a record of previous hostile drone 102 encounters. Each sighting may be logged with a unique identifier or entry number for easy reference and retrieval. This may help in organizing and tracking incidents over time. an essential tool for monitoring, analyzing, and archiving encounters with potentially dangerous unmanned aerial vehicles (UAVs). The hostile drone sighting log 704 may serve not only as a historical record but also as a critical resource for strategic planning, threat assessment, and training purposes. The hostile drone sighting log 704 may include precise recording of the date and time of each sighting, which is crucial for identifying patterns or increases in drone activity in specific areas or during particular events. The hostile drone sighting log 704 may further include detailed geographical information where the drone was spotted. This may include GPS coordinates, as well as a description of the location (e.g., urban area, near critical infrastructure, in a conflict zone). The hostile drone sighting log 704 may include a record of the actions taken in response to the sighting, such as alerts issued, countermeasures deployed (e.g., jamming, interception), and any law enforcement and/or military engagement, etc. The result of the sighting and any response actions, such as the drone being neutralized, captured, or escaping may be recorded by the system in the hostile drone sighting log 704. The hostile drone sighting log 704 may include statements or reports from individuals who witnessed the drone, providing additional context or details about the sighting may be recorded. The hostile drone sighting log 704 may further include photographs, videos, radar images, or other sensor data captured during the incident. These visual aids are invaluable for subsequent analysis and verification, according to one embodiment.

The hostile drone sighting log 704 may allow analysts to identify patterns in drone activity, such as increases in sightings during specific times or in particular locations. This can aid in predictive threat modeling and strategic planning. Data from the log can be used to train personnel in drone detection and response. Real-world cases provide practical scenarios for simulation-based training. Insights gained from past sightings inform the development and refinement of policies and procedures for drone detection and response. The system may maintain a detailed log that supports compliance with legal and regulatory requirements concerning airspace security and UAV regulations. Information in the log can be shared with other agencies or organizations as part of collaborative efforts to enhance airspace security, according to one embodiment.

The hostile drone sighting log 704 may be a vital component of modern security operations, offering a structured and systematic way to record and analyze encounters with hostile UAVs. By maintaining comprehensive records, organizations can enhance their preparedness, response strategies, and overall security posture against the growing threat posed by unauthorized drone use, according to one embodiment.

AI summary of sighting 706 tab may include an AI-generated analyses of drone sightings. The AI summary of sighting 706 may provide detailed information about the drone involved in the sighting, such as type, model, color, and any distinctive features. If the drone matches a known model from the classified UAV catalog 702, this reference may be included in the AI summary of sighting 706. The AI summary of sighting 706 may include observations regarding the drone's behavior and activity during the sighting, such as hovering, circling, photographing, or dropping items. This section can provide insights into the possible intentions behind the drone's presence. In addition, the AI summary of sighting 706 may include details on any visible payload the drone was carrying, such as cameras, sensors, or potentially weapons. This information is critical for assessing the threat level associated with the sighting, according to one embodiment.

Maps and GPS data 708 tab may provide geographical data showing drone locations. The geographic mapping may provide visual representation of hostile drone 202 sightings. The maps 732 may provide a visual layout of the area where drone activity is detected. These maps 732 can range from simple 2D representations to more complex 3D models of the terrain. The maps 732 may include important geographical features, infrastructures, and landmarks are typically highlighted to provide context and assist in navigating or strategizing responses to drone sightings, according to one embodiment.

Maps and GPS data 708 tab may provide GPS coordinates of each drone sighted by the system. Every drone detected may be tagged with precise GPS coordinates, which pinpoint its exact location at the time of observation. This accuracy is crucial for rapid response and historical tracking, according to one embodiment.

The GPS data can also show the path or trajectory of a drone, detailing its movements over time. This is essential for understanding its behavior and potential origin or destination. Each entry in the GPS log may be time-stamped, providing a chronological record of when the drone was at a specific location. This may help in creating a timeline of events, which is useful for investigations and pattern analysis. Maps and GPS data 708 may provide dynamic updates since the tracking information is updated in real-time, allowing operators to monitor drone movements as they happen. This capability is critical for deploying immediate countermeasures or tracking the drone to its origin. Maps and GPS data 708 may be integrated with other surveillance systems, including radar, cameras, and other sensors. This integration provides a comprehensive view of the drone's environment and activities. Storing historical GPS and map data 708 may allow organizations to review past drone activities for patterns or recurring incidents in specific areas. This analysis can inform security planning and preventative measures. Maps enriched with drone location data can be used for tactical planning, especially in military or law enforcement operations. Knowing the geographic layout and the drone's location may help in coordinating effective responses. By providing a geographical visualization of drone locations relative to sensitive or critical areas, maps and GPS data 708 may help assess the risk level and potential impact of drone activities, according to one embodiment.

The maps and GPS data 708 may be used for maintaining airspace security and coordinating defense mechanisms against unauthorized drone intrusions. It may assist in rapid response to illegal drone activities and in gathering evidence for legal actions. The maps and GPS data 708 may be an indispensable tool in modern drone management and airspace security systems. They provide essential geographical insights that enhance the capability to monitor, analyze, and respond to drone-related security challenges effectively, according to one embodiment.

The log files of haptic triggers 710 tab may include records of haptic alerts 118 triggered by hostile drone 202 detections. The log files of haptic triggers 710 may be a critical component in security and surveillance systems, especially when integrated with helmet 102, tactical vest 104 and/or control stations that use haptic feedback to alert operators (e.g., wearers 114) of various incidents, such as hostile drone 202 detections. These logs may record detailed information about each instance where a haptic alert 118 is triggered, providing valuable data for analysis, review, and continuous system improvement. Each haptic alert event in the log files of haptic triggers 710 may be assigned a unique identifier or log entry number, which helps in tracking and referencing specific incidents. Every entry in the log files may be time-stamped with the exact date and time when the haptic alert was triggered. This temporal data is crucial for contextual analysis and correlation with other events or data streams. The log files of haptic triggers 710 may include a detailed description of what triggered the haptic alert 118. For hostile drone detections, this would include the drone's type, the nature of the threat it posed, and any other relevant sensor data that led to the activation of the haptic alert 118. The log files of haptic triggers 710 may provide information about the intensity and pattern of the vibration or other haptic feedback may be provided. Different patterns and intensities can be used to convey different levels of threat or types of alerts. If applicable, GPS coordinates or other location details where the alert was triggered may be logged by the system. The system may further record any immediate response or action taken by the user following the alert. This could include acknowledging the alert, initiating a countermeasure, or other operational procedures, according to one embodiment.

The log files of haptic triggers 710 may enable detailed analysis of each incident, helping to understand how effective the haptic alerts 118 are in prompting necessary actions or responses from the user. Analysis of these logs over time can help identify patterns or trends in hostile drone activity, potentially leading to predictive alerts and more proactive responses, according to one embodiment.

By reviewing how haptic alerts 118 were triggered and responded to, system developers can refine the haptic feedback mechanisms to improve their effectiveness and user-friendliness. Training programs can use historical log data to simulate real-life scenarios, helping operators become more adept at responding to haptic alerts in live situations, according to one embodiment.

The log files of haptic triggers 710 may serve as a vital resource in maintaining the integrity and efficacy of security systems that rely on haptic feedback for alerting operators to potential threats like hostile drones. These logs not only help in immediate incident management but also contribute to long-term security planning, system enhancement, and operational training. They ensure that every triggered response is recorded, analyzed, and used to enhance future alert systems, according to one embodiment.

Realtime data 712 tab may provide current data and alerts about detected drones. The realtime data 712 may include location specifying the exact location of the drone sighting, such as “15 Central Ave, Phoenix”, according to one embodiment

The realtime data 712 may include detailed information about the drone, such as type (e.g., hexacopter), model, payload (e.g., 12 kg), a captured image 734 of the drone, a brief description (e.g., summary 716), and its flight duration and behavior (e.g., “Identified flying for 10 minutes . . . Escaped”). The realtime data 712 may display records of haptic feedback provided in response to the drone, such as alerts for drone detection, weapon detection, and hotspot detection in the haptic feedback data 720 tab, according to one embodiment.

The system may provide an estimated threat level for the sighted hostile drone 202. The summary 716 may include an assessment 736 of intensity of threat from the sighted hostile drone 202. The assessment 736 may be an AI-assessed threat level percentage (e.g., 80%). Sighting log 714 tab may organize and display historical and summary data regarding the drone sightings. The summary 716 tab may provide detailed information about the sighted hostile drone 202, such as type, model, color, any distinctive features, and history of past sightings, etc., according to one embodiment.

The data panel showing the realtime UAV1 data 718 may display detailed information about the classified drone identified by the system, such as type, model, payload, a captured image 734 of the drone, a brief description (e.g., summary 716), and its flight duration and behavior, according to one embodiment.

Haptic feedback data 720 tab may display records of haptic feedback provided in response to the drone, such as alerts for drone detection, weapon detection, and hotspot detection. The AI video analysis 722 may allow users to view real-time and/or recorded video feeds analyzed by AI. The haptic history 724 tab may display the reviews of the history of haptic feedback. The threat map 726 tab may provide a strategic map indicating current threats from the sighted hostile drone 202, according to one embodiment.

Ask AI 728 tab may be a feature to query the AI system for specific information or advice. The save 730 tab may provide an option to save the current data or reports for later review. The helmet 102 system's AI model 110 plays a critical role in automatically generating detailed descriptions (e.g., summary 716) of detected drones, assessing threat levels (e.g., using threat map 726 and assessment 736), and summarizing sighting information. This facilitates rapid understanding and response to potential threats, according to one embodiment.

The helmet 102 system's AI model 110 may ensure that users receive immediate updates about any hostile drone 202 activity, enabling quick tactical decisions. The helmet 102 system's AI model 110 may seamlessly combine live data, historical logs, and AI analytics, presenting a holistic view of the situation to the wearer 114, according to one embodiment.

This user interface shown in the user interface view 750 is a sophisticated example of how modern technology, especially AI, can be utilized to enhance security and situational awareness. By providing detailed, real-time information through an easily navigable mobile interface, it helps security personnel, law enforcement, or military operators make informed decisions quickly and effectively in critical situations.

FIG. 8 is a conceptual view 850 of a birdwatching detection system of the skyward facing visual sensor 100 of FIG. 1, according to one embodiment.

FIG. 8 illustrates a birdwatching embodiment with Generative AI and Mobile/Web App Integration of the skyward facing visual sensor 100, according to one embodiment. Aiming to transform the birdwatching experience, a revolutionary helmet-based birdwatching detection system has been developed, according to one embodiment. This advanced system harnesses the power of artificial intelligence (e.g., using AI model 110), generative AI (e.g., using data pipeline 504 of FIG. 5), and seamless integration with mobile and web applications (e.g., using user interface view 750) to offer birdwatchers an unparalleled tool for identifying, describing, and cataloging their avian observations, according to one embodiment.

The core of this innovative system lies in a low-profile, concavely curved camera housing 116, specifically designed for mounting on the top of a headgear (e.g., a helmet 102, a hat, etc.), according to one embodiment. This camera housing 116 encases a skyward-facing visual sensor 100 that continuously captures images of the sky above the user 806 (e.g., wearer 114). The sensor's strategic positioning may ensure an unobstructed view 802, enabling the system to efficiently monitor the sky for bird activity, according to one embodiment.

Captured images 804_{1-N} of birds 212_{1-N} may be processed by a sophisticated artificial intelligence model 110 integrated within the system, according to one embodiment. This AI model 110 may be meticulously trained to recognize a wide variety of bird species, analyzing characteristics such as size, flight patterns, and distinctive visual features, according to one embodiment. It may adeptly differentiate birds 212 from other objects, like drones (e.g., hostile drone 202, loitering munition 206) or planes, ensuring precise identification, according to one embodiment.

Upon detecting a bird 212, the system's generative AI component may generate detailed descriptions (e.g., summary 716) of the observed bird 212, according to one embodiment. These descriptions include information about the species, behavior, and notable characteristics. Simultaneously, the system may automatically capture images 804 of the bird 212. The user 806 (e.g., wearer 114) may receive a haptic notification through a device (e.g., responsive device 108) embedded in the headgear (e.g., helmet 102) or tactical vest 104, which gently vibrates to signal the presence and description of the bird 212. This immediate notification allows birdwatchers to quickly locate and observe the bird 212, enhancing their overall experience, according to one embodiment.

Furthermore, the system offers 360-degree situational awareness through an array 350 of additional visual sensors placed around the camera housing 116 of the headgear (e.g., helmet 102), providing comprehensive sky coverage. Birdwatchers can be assured that no bird 212 will go unnoticed, regardless of its position in the sky, according to one embodiment.

The camera housing 116 may be designed for versatility and case of use, according to one embodiment. It can be attached to different parts of the headgear (e.g., helmet 102) or vest using a hook and loop method, allowing user 806 (e.g., wearer 114) to reposition it as needed, according to one embodiment. This adaptability ensures the system can be customized to suit individual preferences and requirements, according to one embodiment.

In addition to real-time detection and notification, the system may pair with a mobile or web app for automatic cataloging of sightings (e.g., using AI summary of sightings 706 of analytics summary 700), according to one embodiment. Captured images 804 and generated descriptions may be seamlessly saved in the app, which users can access at their convenience, according to one embodiment. The app may allow users to customize preferences for the types of birds 212 they are interested in, filter and highlight sightings based on these preferences, and maintain a historical record of their birdwatching activities along with GPS locations and a map view where the birds 212 were seen, according to one embodiment.

FIG. 9 is a conceptual view 950 of an astronomy system of the headgear (helmet 102 may be any kind of headgear) based on visual observation of the skyward facing visual sensor 100 of FIG. 1, according to one embodiment.

FIG. 9 illustrates a skywatching embodiment with Generative AI and Mobile/Web App Integration of the skyward facing visual sensor 100, according to one embodiment. Skywatching enthusiasts may now have access to an innovative headgear-based detection system that elevates their observational experience, according to one embodiment. This system, designed to assist skywatchers in identifying, describing, and documenting celestial phenomena, integrates artificial intelligence (e.g., using AI model 110), generative AI (e.g., using data pipeline 504 of FIG. 5), and mobile/web app functionalities (e.g., using user interface view 750), according to one embodiment.

The system features a low-profile, concavely curved camera housing 116 mounted on the top of a headgear (e.g., helmet 102), according to one embodiment. This camera housing 116 contains a skyward-facing visual sensor 100 that captures images of the vast expanse of the sky above the user 806 (e.g., wearer 114), according to one embodiment. Positioned for optimal view, the sensor ensures efficient sky monitoring, according to one embodiment.

Captured images 804_{1-N} may be analyzed by an integrated artificial intelligence model 110 specialized in detecting celestial objects 902 such as stars, planets, and satellites, according to one embodiment. Using sophisticated algorithms and anomaly detection techniques, the AI model 110 may differentiate between normal sky conditions and the presence of celestial objects 902, according to one embodiment. By evaluating the expected appearance of the sky under normal conditions, the AI model 110 can accurately identify anomalies signifying celestial objects 902, according to one embodiment.

Upon detecting a celestial object 902, the system's generative AI generates detailed descriptions (e.g., summary 716), including the object's name, characteristics, and historical significance, according to one embodiment. Simultaneously, the system captures images of the detected celestial object 902. The user 806 (e.g., wearer 114) may be alerted through a haptic feedback device embedded in the headgear (e.g., helmet 102) and/or tactical vest 104, which gently vibrates to signal the presence and description of the object, according to one embodiment. This immediate notification enables skywatchers to promptly direct their attention to the detected object, enhancing their observational experience, according to one embodiment.

The system also offers 360-degree situational awareness through multiple visual sensors placed around the headgear (e.g., helmet 102), ensuring comprehensive sky coverage, according to one embodiment. This feature guarantees that no celestial event is missed, according to one embodiment.

Designed for flexibility and user convenience, the camera housing 116 can be attached to various parts of the headgear (e.g., helmet 102) and/or vest using a hook and loop method, allowing users to reposition it according to their preferences, according to one embodiment. This adaptability ensures the system can be tailored to meet the specific needs of individual skywatchers, according to one embodiment.

An additional benefit of this system is its integration with a mobile or web app for automatic cataloging of sightings (e.g., using AI summary of sightings 706 of analytics summary 700). Captured images 804_{1-N} and generated descriptions are saved in the app along with the location and GPS coordinates (e.g., using maps and GPS data 708) when and where they were seen and what location in the sky, which users 806 (e.g., wearer 104) can access anytime, according to one embodiment. The app allows users 806 to customize preferences for the types of celestial objects 902 they are interested in, filter and highlight sightings based on these preferences, and maintain a historical record of their skywatching activities, according to one embodiment.

In conclusion, these enhanced embodiments of helmet-based detection systems for birdwatching and skywatching offer state-of-the-art solutions for enthusiasts. By integrating generative AI and mobile/web app functionalities, these systems provide detailed descriptions, capture and catalog images, and personalize the experience based on user preferences, making birdwatching and skywatching more engaging and informative than ever before, according to one embodiment.

Alternative embodiments of camera housing 116. It should be understood that the camera housing 116 can be designed for civilian use cases as well military ones, according to embodiments of FIGS. 1-9.

Many embodiments have been described. Nevertheless, it will be understood that various modifications may be made without departing from the spirit and scope of the claimed invention. For example, the skyward facing visual sensor 100 may be any of the visual sensors of the array 350 integrated within the tactical gear 104 in any form (e.g., including helmet 102 form). Also, embodiments described for one use case, such as for law enforcement, may apply to any of the other use cases described herein in any form. In addition, the logic flows depicted in FIGS. 1-9 do not require the particular order shown, or sequential order, to achieve desirable results. In addition, other steps may be provided, or steps may be eliminated, from the described flows. Other components may be added or removed from the described systems. Accordingly, other embodiments are within the scope of the following claims. It may be appreciated that the various systems, methods, and apparatus disclosed herein may be embodied in a machine-readable medium and/or a machine-accessible medium compatible with a data processing system (e.g., a computer system), and/or may be performed in any order.

Although the present embodiments have been described with reference to specific example embodiments, it will be evident that various modifications and changes may be made to each of the embodiments in the FIGS. 1-9 without departing from the broader spirit and scope of the various embodiments. Features in one embodiment and use case may be applicable to other use cases as described, and one with skill in the art will appreciate this and those interchanges are incorporated as embodiments of each use case-fire, military, police, civilian, journalism, EMT etc. For example, the various devices and modules described herein may be enabled and operated using hardware circuitry (e.g., GPUs, CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., graphics processing units (GPUs), application-specific integrated (ASIC) circuitry and/or Digital Signal Processor (DSP) circuitry). In addition, it may be appreciated that the various systems, methods, and apparatus disclosed herein may be embodied in a machine-readable medium and/or a machine-accessible medium compatible with a data processing system (e.g., a computer system), and/or may be performed in any order. The structures and modules in FIGS. 1-9 may be shown as distinct and communicating with only a few specific structures and not others. The structures may be merged with each other, may perform overlapping functions, and may communicate with other structures not shown to be connected in the Figures.

Many embodiments have been described. Nevertheless, it will be understood that various modifications may be made without departing from the spirit and scope of the claimed invention. For example, the GovGPT™ Body-worn safety device may be the GovGPT™ tactical gear in any form (e.g., including helmet form). Also, embodiments described for one use case, such as for law enforcement, may apply to any of the other use cases described herein in any form. In addition, the logic flows depicted in the Figures do not require the particular order shown, or sequential order, to achieve desirable results. In addition, other steps may be provided, or steps may be eliminated, from the described flows. Other components may be added or removed from the described systems. Accordingly, other embodiments are within the scope of the following claims.

1. A low profile, concavely curved camera housing, comprising:
a skyward facing visual sensor on a top surface of the low profile, concavely curved camera housing, to capture an ambient sky above a wearer of a helmet;
an artificial intelligence model communicatively coupled with the skyward facing visual sensor to detect an object of interest; and
a responsive device to notify the wearer when the artificial intelligence model detects the object of interest.

2. The low profile, concavely curved camera housing of claim 1 to utilize the artificial intelligence model to differentiate a bird from a loitering munition, and to classify the loitering munition as at least one of a friendly drone and a hostile drone.

3. The low profile, concavely curved camera housing of claim 2 wherein the responsive device to notify the wearer only when the object of interest is the hostile drone.

4. The low profile, concavely curved camera housing of claim 1 wherein the artificial intelligence model to utilize sky canceling machine learning to ignore a sky through a neural network that evaluates what an appearance is of an expected sky in a normal condition as opposed to an anomalous condition when the object of interest is present in the sky.

5. The low profile, concavely curved camera housing of claim 1 wherein the object of interest is any one of a drone, a bird, a plane, a missile, a satellite, an ambient threat, and a celestial object.

6. The low profile, concavely curved camera housing of claim 1 wherein an attachment means is by way of a hook and loop method that permits the wearer to reposition the low profile, concavely curved camera housing on other parts of the helmet and on a tactical vest worn by the wearer.

7. The low profile, concavely curved camera housing of claim 1 wherein the responsive device is a haptic sensor on any one of the helmet and a tactical vest of the wearer.

8. The low profile, concavely curved camera housing of claim 1 wherein an array of visual sensors are found on different sides of the low profile, concavely curved camera housing to provide 360 degree situational awareness to the wearer when an ambient threat is detected to the wearer using the artificial intelligence model.

9. The low profile, concavely curved camera housing of claim 1 wherein the responsive device to provide a haptic feedback to indicate at least one of a source, a direction, an elevation, and a proximity of an imminent drone attack.

10. The low profile, concavely curved camera housing of claim 1 wherein a multistatic radar on the tactical vest of the wearer to detect a loitering munition.

11. The low profile, concavely curved camera housing of claim 1 wherein a command center to direct a series of counter measures to neutralize the hostile drone in the imminent drone attack.

12. The low profile, concavely curved camera housing of claim 1 wherein the artificial intelligence model to differentiate the hostile drone from another object, such as the bird and a plane, based on at least one of a size, a speed, a flight pattern, a visual characteristic, and an acoustical characteristic.

13. The low profile, concavely curved camera housing of claim 12 wherein the artificial intelligence model to identify at least one of a drone type, a model, and a potentially of its payload of the hostile drone in the imminent drone attack by comparing sensor data against databases of known drone signatures to assess a level of threat, classify at least one of the drone type, the model, and the potentially of its payload of the hostile drone, and to decide on an appropriate response.

14. The low profile, concavely curved camera housing of claim 1 wherein a counter-drone response system of the command center to control an electronic warfare tool, such as a RF jammer and a spoofer, to disrupt at least one of a communication system and a navigation system of the hostile drone, forcing it to at least one land and return to its point of origin.

15. The low profile, concavely curved camera housing of claim 1 to employ AI systems to continuously learn from encounters during imminent attacks, improving detection, identification, and interception capabilities of a loitering munition over time.

16. A counter-UAS (Unmanned Aircraft System) comprising:
a skyward facing visual sensor on a top surface of a low profile, concavely curved camera housing, to capture an ambient sky above a wearer of a helmet;
an artificial intelligence model communicatively coupled with the skyward facing visual sensor to detect at least one of a loitering munition and a bird; and
a personal protective equipment having a responsive device integrated in at least one of a tactical gear and the helmet to haptically notify the wearer when the artificial intelligence model detects a hostile drone approaching a location having a blast radius of the wearer of the personal protective equipment.

17. The counter-UAS of claim 16 further comprising:
a sensor system communicatively coupled with the personal protective equipment to employ a sensor comprising any of a radar, a radio frequency (RF) scanner, an acoustic sensor, and an optical camera to detect a presence of the hostile drone approaching the location having the blast radius of the wearer of the personal protective equipment.

18. The counter-UAS of claim 16 further comprising a counter-drone response system of at least one of the personal protective equipment and a command center to control an electronic warfare tool, such as a RF jammer and a spoofer, to disrupt at least one of a communication system and a navigation system of the hostile drone in the imminent attack, forcing it to at least one land and return to its point of origin.

19. The counter-UAS of claim 16 further comprising an anti-swarm module of at least one of the personal protective equipment and the command center to track and neutralize multiple hostile drones simultaneously, wherein the sensor system to deploy a cope cage on at least one of a vehicle, an infrastructure, and the wearer of the tactical gear.

20. A wearable device, comprising:
a responsive device to haptically notify a wearer of a helmet when a skyward facing visual sensor sees an object of interest; and
a artificial intelligence model to utilize sky canceling machine learning to ignore a sky through a neural network that evaluates what an appearance is of an expected sky in a normal condition as opposed to an anomalous condition when the object of interest is present in the sky surrounding the wearer and within view of the skyward facing visual sensor.
